(19) United States
(12) Patent Application Publication
(10) Pub. No.: US 2025/0277942 A1
(43) Pub. Date: Sep. 4, 2025

(54) FIBER ARRAY UNIT WITH GUIDE MEMBERS

(71) Applicant: CORNING RESEARCH & DEVELOPMENT CORPORATION, CORNING, NY (US)

(72) Inventors: Michael Alan Bell, Newton, NC (US); Shudong Xiao, Fremont, CA (US); Andy Fenglei Zhou, Fremont, CA (US)

(21) Appl. No.: 19/210,458

(22) Filed: May 16, 2025

Related U.S. Application Data
(63) Continuation of application No. PCT/US2023/079755, filed on Nov. 15, 2023.
(60) Provisional application No. 63/428,136, filed on Nov. 28, 2022.

(51) Int. Cl. G02B 6/38

(52) U.S. Cl. CPC G02B 6/3882

(57) ABSTRACT

Fiber array unit assemblies and methods of manufacturing the same are provided herein. A fiber array unit includes a first set of optical fibers, a first guide member, and a second guide member. The fiber array unit includes a fiber array structure having a surface that defines a first groove and a second groove. The surface defines a first area between the first groove and the second groove, wherein the first area is provided without any grooves. The first guide member is received in the first groove to assist in positioning the first guide member relative to the fiber array structure. The second guide member is received in the second groove to assist in positioning the second guide member relative to the fiber array structure. Each optical fiber of the first set of optical fibers is positioned between the first guide member and the second guide member.

### PRIORITY APPLICATIONS

This application is a continuation of International Patent Application No. PCT/US2023/079755 filed Nov. 15, 2023, which claims the benefit of priority of U.S. Provisional Application Ser. No. 63/428,136 filed on Nov. 28, 2022, the content of which is relied upon and incorporated herein by reference in its entirety.

### FIELD

Embodiments of the present invention relate generally to fiber array units having guide members and, more particularly, to fiber array units that enable passive alignment of optical fibers without grooves for individual optical fibers.

### BACKGROUND

Substrates have been provided that are configured to position optical fibers so that the optical fibers may form an optical interconnect. Some of these substrates possess grooves for each optical fiber in attempt to control the position of each optical fiber, and this results in substrates that are complex and more costly to manufacture. Other substrates are provided without any grooves, increasing the difficulty of alignment of optical fibers and increasing the risk of inaccuracy of optical fiber positioning, which can lead to, for example, signal loss during connection, wasted time during assembly, and/or waste of the entire fiber array.

### BRIEF SUMMARY

Embodiments of the present invention relate to a fiber array unit with two or more guide members. The fiber array unit may include a fiber array structure with grooves, and the grooves may be configured to receive the guide members. The fiber array unit may be provided without grooves for each of the individual optical fibers, and optical fibers may be positioned between the guide members. The guide members may serve as sidewalls that assist in positioning the optical fibers, enabling effective passive alignment of the optical fibers. With the optical fibers positioned appropriately, the optical fibers may be fixed relative to the fiber array structure to retain the optical fibers in the appropriate position. Because the fiber array structure is provided without grooves for each optical fiber, the fiber array structure may be made with lower manufacturing costs while still allowing the optical fibers to be positioned appropriately.

Dummy fibers may also be utilized to effectively control the position of the optical fibers, and dummy fibers may enable the fiber array unit to be more easily adaptable to various use cases. A single layer of optical fibers may be provided in some embodiments, but multiple layers of optical fibers may be vertically stacked on the fiber array structure. Where multiple layers of optical fibers are provided in a fiber array unit, the layers may be stacked in a staggered manner, allowing the fiber array unit to be provided with a high optical fiber density. Furthermore, fixtures may be utilized to aid in positioning the guide members and/or the optical fibers. In some embodiments, multiple fixtures may be used to make the fiber array unit, with different fixtures being utilized to position the guide members, to position a first layer of optical fibers, and/or to position one or more additional layers of optical fibers. However, the same fixture may be utilized to perform multiple tasks in manufacturing the fiber array unit.

In an example embodiment, a fiber array unit is provided comprising a first set of optical fibers, a first guide member and a second guide member, and a fiber array structure having a surface. The surface of the fiber array structure defines a first groove and a second groove, with the surface defining a first area between the first groove and the second groove. The first area is provided without any grooves. Furthermore, the first guide member is at least partially received in the first groove to assist in positioning the first guide member relative to the fiber array structure, and the second guide member is at least partially received in the second groove to assist in positioning the second guide member relative to the fiber array structure. Each optical fiber of the first set of optical fibers is positioned between the first guide member and the second guide member.

In some embodiments, the fiber array unit may also include a second set of optical fibers. The first set of optical fibers may be positioned vertically between the first area and the second set of optical fibers. Each optical fiber of the second set of optical fibers may contact another optical fiber of the first set of optical fibers. Additionally, in some embodiments, an optical fiber of the second set of optical fibers may be positioned such that it comes in contact with two optical fibers of the first set of optical fibers. Furthermore, in some embodiments, the first set of optical fibers and the second set of optical fibers may be stacked in a staggered manner.

In some embodiments, the first set of optical fibers may be fixed to the first area. Additionally, in some embodiments, the first set of optical fibers may be fixed to the first area through laser welding or via adhesive.

In some embodiments, the fiber array unit also may include a first set of one or more dummy fibers and a second set of one or more dummy fibers. The first set of one or more dummy fibers and the second set of one or more dummy fibers may contact the first area. A first dummy fiber of the first set of one or more dummy fibers may contact the first guide member. Either the first dummy fiber or a second dummy fiber of the first set of one or more dummy fibers may contact a first optical fiber of the first set of optical fibers, a first dummy fiber of the second set of one or more dummy fibers may contact the second guide member, and either the first dummy fiber or a second dummy fiber of the second set of one or more dummy fibers may contact a second optical fiber of the first set of optical fibers. The first optical fiber of the first set of optical fibers may be positioned at a first end of the first set of optical fibers, the second optical fiber of the first set of optical fibers may be positioned at a second end of the first set of optical fibers, and the second end of the first set of optical fibers may be opposite to the first end of the first set of optical fibers.

In some embodiments, the first groove and the second groove may both be V-grooves. In some embodiments, the first area may define a flat plane. In some embodiments, the first guide member and the second guide member may be at least one of a guide pin, an optical fiber, or a dummy fiber. Furthermore, in some embodiments, the first guide member may define a first guide member cross-sectional area, an optical fiber of the first set of optical fibers may define an optical fiber cross-sectional area, and the first guide member cross-sectional area may be greater than the optical fiber cross-sectional area. In some embodiments, the first set of optical fibers, the first guide member, and the second guide member may each possess a circular cross-section.

In some embodiments, the first set of optical fibers may be positioned by application of force onto the first set of optical fibers via a first fixture. Additionally, in some embodiments, the first fixture may define a first groove and a second groove, the first groove may be configured to at least partially receive the first guide member, and the second groove may be configured to at least partially receive the second guide member. Furthermore, the first fixture may define a plurality of grooves positioned between the first groove and the second groove, and each groove of the plurality of grooves may be configured to at least partially receive an optical fiber of the first set of optical fibers. In some embodiments, the first fixture may define a plurality of grooves, and each groove of the plurality of grooves may be configured to at least partially receive an optical fiber of the first set of optical fibers. Additionally, in some embodiments, the first fixture may be fixed relative to the fiber array structure after the first set of optical fibers is positioned.

In some embodiments, the first fixture may be removed after the first set of optical fibers is positioned. Furthermore, in some embodiments, the fiber array unit may further comprise a second set of optical fibers. The first set of optical fibers may be positioned vertically between the first area and the second set of optical fibers, each optical fiber of the second set of optical fibers may contact the first set of optical fibers, and the second set of optical fibers may be positioned against the first set of optical fibers by application of force onto the second set of optical fibers via the first fixture. Additionally, in some embodiments, the fiber array unit may also include a second set of optical fibers. The first set of optical fibers may be positioned vertically between the first area and the second set of optical fibers, each optical fiber of the second set of optical fibers may contact the first set of optical fibers, and the second set of optical fibers may be positioned against the first set of optical fibers by application of force onto the second set of optical fibers via a second fixture.

In another example embodiment, a method of making a fiber array unit is provided. The method comprises providing a first set of optical fibers, a first guide member, a second guide member, and a fiber array structure. The fiber array structure has a surface, with the surface defining a first groove and a second groove. The surface also defines a first area between the first groove and the second groove, and the first area is provided without any grooves. The method also includes positioning the first guide member in the first groove, positioning the second guide member in the second groove, positioning the first set of optical fibers so that each optical fiber of the first set of optical fibers contacts the first area so as to be positioned between the first guide member and the second guide member, and fixing the first set of optical fibers relative to the fiber array structure.

In some embodiments, the first set of optical fibers may be fixed relative to the fiber array structure through laser welding or via adhesive. Additionally, in some embodiments, a first fixture may be used to aid in positioning the first guide member in the first groove and to aid in positioning the second guide member in the second groove. In some embodiments, the method may also include providing a first fixture and positioning the first set of optical fibers by application of force onto the first set of optical fibers via the first fixture. Furthermore, in some embodiments, the method may also include providing a second set of optical fibers, positioning the second set of optical fibers such that the first set of optical fibers is positioned vertically between the first area and the second set of optical fibers, and fixing the second set of optical fibers relative to the fiber array structure.

In another example embodiment, a fiber array unit is provided having a first set of optical fibers, a first guide member, a second guide member, and a fiber array structure. The fiber array structure has a surface, and the surface is provided without any grooves. The first guide member is positioned at a first location on the surface, the second guide member is positioned at a second location on the surface, and each optical fiber of the first set of optical fibers is positioned between the first guide member and the second guide member.

In some embodiments, the first guide member may be positioned at the first location by application of force onto the first guide member via a first fixture. The first fixture may define a first groove, and the first groove may be configured to at least partially receive the first guide member to aid in positioning the first guide member at the first location. The second guide member may be positioned at the second location by application of force onto the second guide member via the first fixture. The first fixture may define a second groove, and the second groove may be configured to at least partially receive the second guide member to aid in positioning the second guide member at the second location.

### BRIEF DESCRIPTION OF THE DRAWINGS

Having thus described the invention in general terms, reference will now be made to the accompanying drawings, which are not necessarily drawn to scale, and wherein:

FIG. 1A is a perspective view illustrating an example fiber array unit, in accordance with some embodiments discussed herein;

FIG. 1B is a front view illustrating the fiber array unit of FIG. 1A, in accordance with some embodiments discussed herein;

FIG. 1C is an enhanced, front view illustrating the fiber array unit of FIG. 1A where adhesive is utilized to fix optical fibers to a fiber array structure of the fiber array unit, in accordance with some embodiments discussed herein;

FIG. 1D is an enhanced, front view illustrating the fiber array unit of FIG. 1A where laser welding is utilized to fix optical fibers to a fiber array structure of the fiber array unit, in accordance with some embodiments discussed herein;

FIG. 2A is a perspective view illustrating a first example fixture being used to form an example fiber array unit, in accordance with some embodiments discussed herein;

FIG. 2B is a perspective view illustrating an example fiber array structure with guide members positioned in grooves of the fiber array structure, in accordance with some embodiments discussed herein;

FIG. 2C is a perspective view illustrating a second example fixture being used to position optical fibers, in accordance with some embodiments discussed herein;

FIG. 3A is a perspective view illustrating an example fiber array unit where optical fibers extend beyond a front edge of the fiber array structure, in accordance with some embodiments discussed herein;

FIG. 3B is a side view illustrating the example fiber array unit of FIG. 3A, in accordance with some embodiments discussed herein;

FIG. 3C is a perspective view illustrating an example fiber array unit where guide members extend beyond a front edge of the fiber array structure, in accordance with some embodiments discussed herein;

FIG. 3D is a perspective view illustrating an example fiber array unit where guide members and optical fibers extend beyond a front edge of the fiber array structure, in accordance with some embodiments discussed herein;

FIG. 4A is a perspective view illustrating an example fiber array unit where dummy fibers are used, in accordance with some embodiments discussed herein;

FIG. 4B is a front view illustrating the fiber array unit of FIG. 4A, in accordance with some embodiments discussed herein;

FIG. 5A is a perspective view illustrating another example fiber array unit where space is left between guide members and optical fibers, in accordance with some embodiments discussed herein;

FIG. 5B is a perspective view illustrating an example fixture being used to form the fiber array unit of FIG. 5A, in accordance with some embodiments discussed herein;

FIG. 5C is a front view illustrating the fixture and the fiber array unit of FIG. 5B, in accordance with some embodiments discussed herein;

FIG. 5D is an enhanced, front view illustrating the fixture and the fiber array unit of FIG. 5C, in accordance with some embodiments discussed herein;

FIG. 6A is a perspective view illustrating another example fiber array unit where space is left between optical fibers, in accordance with some embodiments discussed herein;

FIG. 6B is a perspective view illustrating the fiber array unit of FIG. 6A with an example fixture being used to assist in forming the fiber array unit, in accordance with some embodiments discussed herein;

FIG. 6C is a front view illustrating the fiber array unit and fixture of FIG. 6B, in accordance with some embodiments discussed herein;

FIG. 7A is a perspective view illustrating another example fiber array unit where dummy fibers are used and where optical fibers are stacked in multiple layers, in accordance with some embodiments discussed herein;

FIG. 7B is a front view illustrating the fiber array unit of FIG. 7A, in accordance with some embodiments discussed herein;

FIG. 7C is a front view illustrating a first example fixture being used to assist in positioning a first layer of fibers of the fiber array unit of FIG. 7A, in accordance with some embodiments discussed herein;

FIG. 7D is a front view illustrating a second example fixture being used to assist in positioning a second layer of fibers of the fiber array unit of FIG. 7A, in accordance with some embodiments discussed herein;

FIG. 8A is a front view illustrating another example fiber array unit where optical fibers are stacked in multiple layers and where space is left between the optical fibers and guide members, in accordance with some embodiments discussed herein;

FIG. 8B is a perspective view illustrating the fiber array unit of FIG. 8A, in accordance with some embodiments discussed herein;

FIG. 8C is a front view illustrating a first example fixture being used to assist in positioning a first layer of fibers of the fiber array unit of FIG. 8A, in accordance with some embodiments discussed herein;

FIG. 8D is a front view illustrating a second example fixture being used to assist in positioning a second layer of fibers of the fiber array unit of FIG. 8A, in accordance with some embodiments discussed herein;

FIG. 9A is a perspective view illustrating another example fiber array unit where three guide members are used, in accordance with some embodiments discussed herein;

FIG. 9B is a perspective view illustrating an example fixture being used to assist in forming the fiber array unit of FIG. 9A, in accordance with some embodiments discussed herein;

FIG. 9C is a front view illustrating the fixture and fiber array unit of FIG. 9B, in accordance with some embodiments discussed herein;

FIG. 10 is a perspective view illustrating an example fiber array unit where optical fibers are spliced together, in accordance with some embodiments discussed herein;

FIG. 11 is a flow chart illustrating an example method of making a fiber array unit, in accordance with some embodiments discussed herein;

FIG. 12 is a flow chart illustrating an example method of making a fiber array unit, in accordance with some embodiments discussed herein; and

FIG. 13 is a flow chart illustrating an example method of making a fiber array unit having multiple layers, in accordance with some embodiments discussed herein.

### DETAILED DESCRIPTION

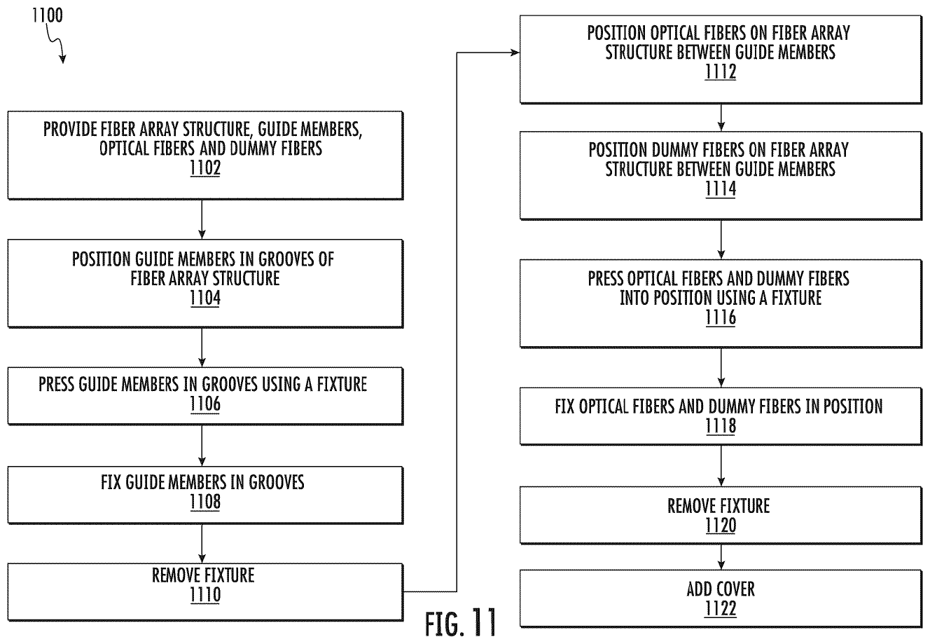

Example embodiments of the present invention now will be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. Other than the reference numerals presented in FIGS. 11-13, like reference numerals generally refer to like elements. For example, reference numerals 110, 610A, 610B, 710A, 710B, etc. each refer to optical fibers. Additionally, any connections or attachments may be direct or indirect connections or attachments unless specifically noted otherwise.

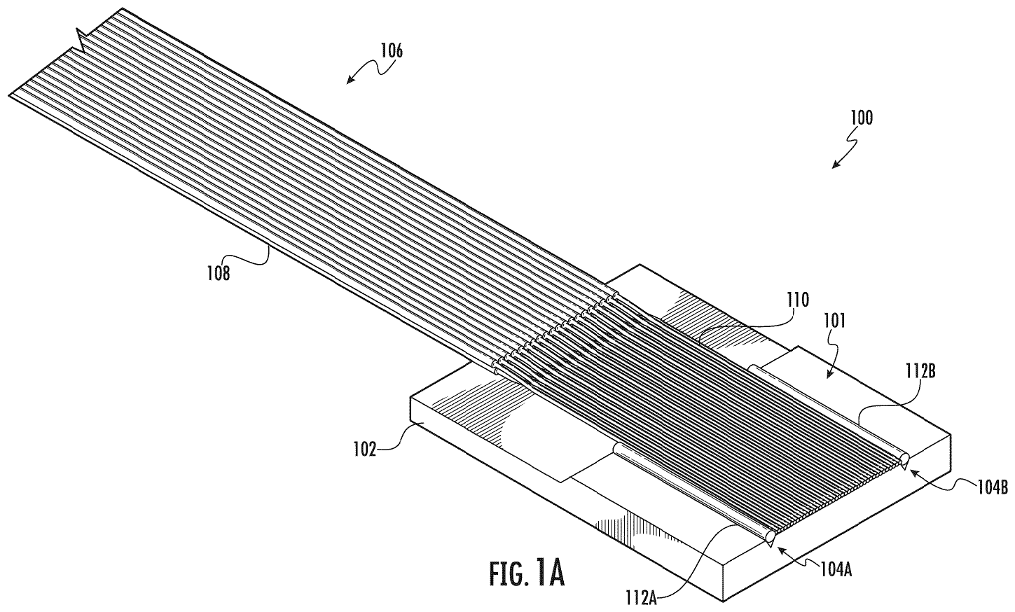

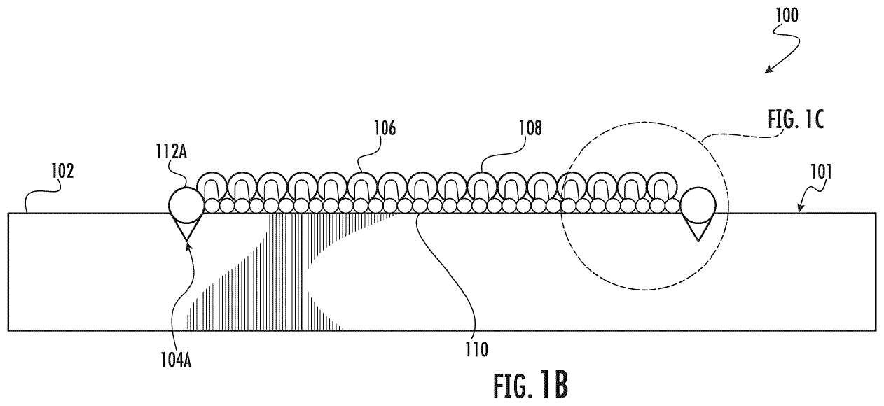

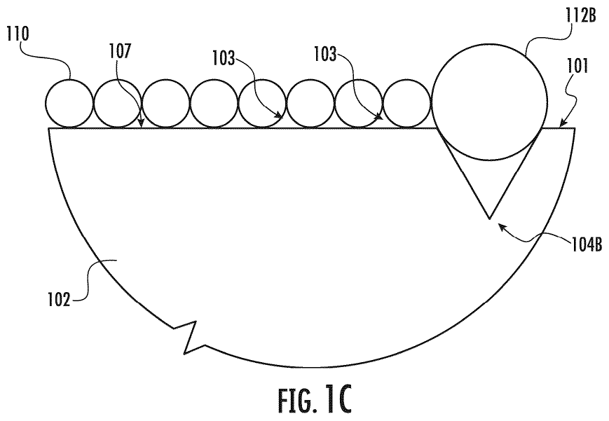

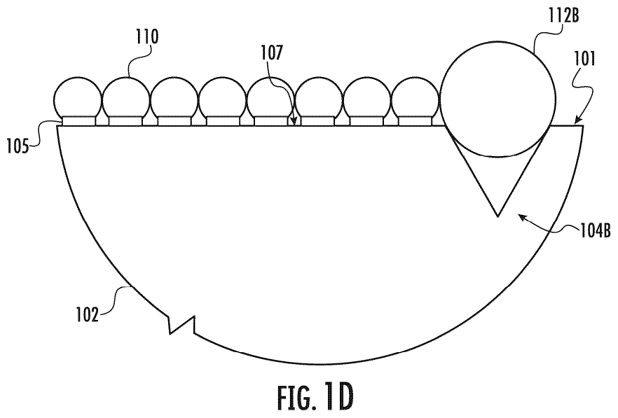

Example embodiments provide fiber array units where optical fibers are effectively positioned on a surface of a fiber array structure, with the surface being manufactured without grooves for each optical fiber. In FIGS. 1A-1B, an example of such a fiber array unit 100 is illustrated, with FIG. 1A providing a perspective view and with FIG. 1B providing a front view.

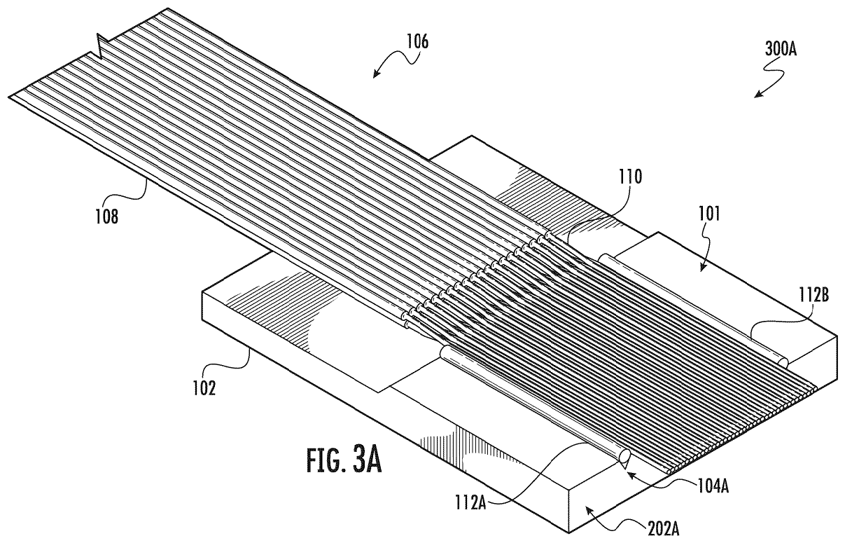

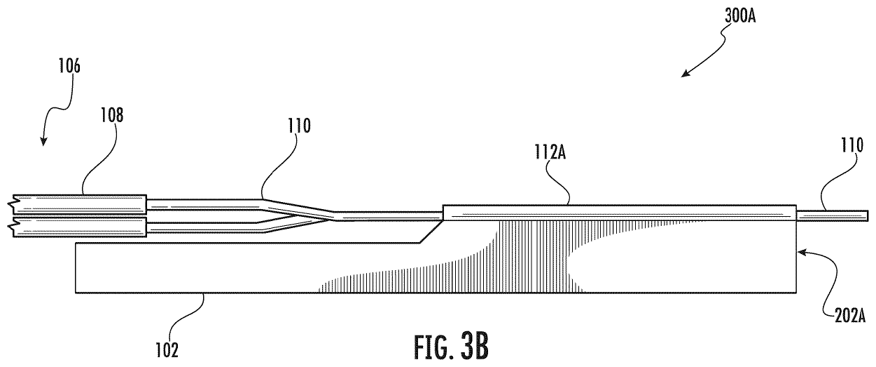

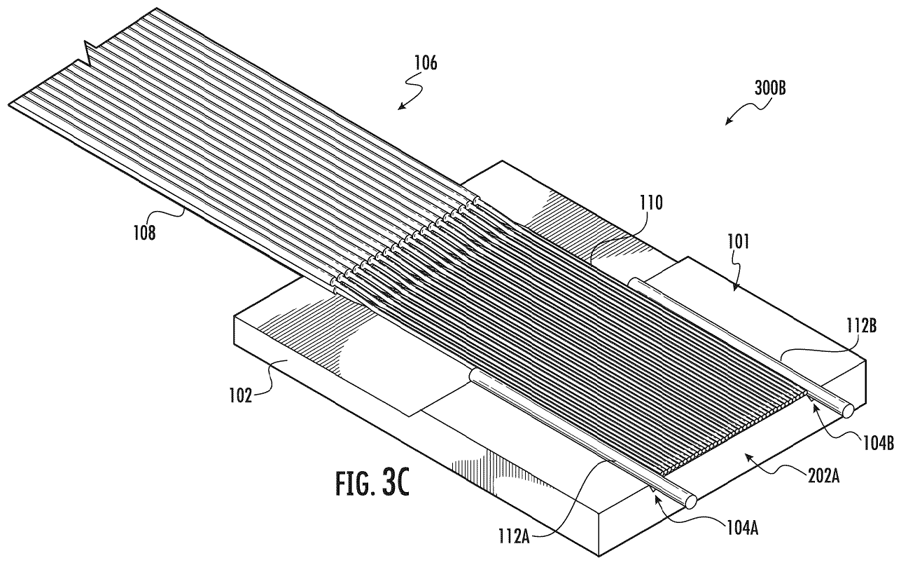

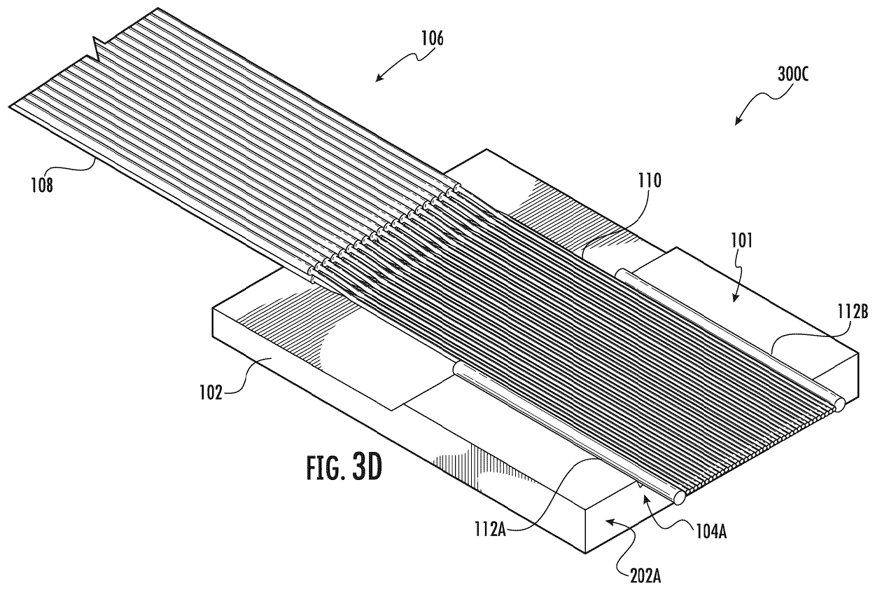

Covered optical fibers 106 are illustrated in FIG. 1A. Each covered optical fiber 106 has an outer coating 108 and an optical fiber 110 within the outer coating 108. The optical fibers 110 form part of the fiber array unit 100 in FIG. 1A. In some embodiments, the covered optical fibers 106 may be provided as part of a fiber ribbon, with multiple covered optical fibers 106 retained together. In the illustrated embodiment, the covered optical fibers 106 are stacked in two layers, and the outer coating 108 of adjacent covered optical fibers 106 in each layer may contact each other to minimize the pitch between covered optical fibers 106. The pitch between covered optical fibers 106 may be measured from the center of one covered optical fiber 106 to the center of an adjacent covered optical fiber 106. The covered optical fibers 106 have a larger cross-sectional area than the cross-sectional area of each optical fiber 110. Thus, when the outer coating 108 of the covered optical fibers 106 is removed, the pitch between optical fibers 110 may be reduced as compared to the pitch between covered optical fibers 106, and the smaller sized optical fibers 110 may be provided in a single layer. FIG. 3B illustrates an example embodiment where two layers of covered optical fibers 106 are provided, where outer coating 108 is removed to expose optical fibers 110 therein, and where the optical fibers 110 are merged into a single layer.

The fiber array unit 100 also includes a fiber array structure 102. The fiber array structure 102 has a surface 101 defining a first groove 104A and a second groove 104B. In the illustrated embodiment, the surface 101 is the top surface of an elevated portion of the fiber array structure 102. Additionally, the first groove 104A and the second groove 104B may take a variety of shapes and sizes. In some embodiments, the first groove 104A and the second groove 104B may both be V-grooves. However, the first groove 104A and the second groove 104B may take other shapes such as a rectilinear shape, a square shape, a rectangular shape, a trapezoidal shape, a circular shape, an oval shape, an asymmetrical shape, or some other shape.

Additionally, the fiber array unit 100 includes a first guide member 112A and a second guide member 112B. As illustrated in FIG. 1A, the first guide member 112A is partially received in the first groove 104A to assist in positioning the first guide member 112A relative to the fiber array structure 102, and the second guide member 112B is partially received in the second groove 104B to assist in positioning the second guide member 112B relative to the fiber array structure 102. The first guide member 112A and the second guide member 112B may take a variety of forms. In some embodiments, the guide members may be guide pins or dummy fibers. In some embodiments, the first guide member 112A and the second guide member 112B may be larger than the optical fibers 110 such that a cross-sectional area and/or height (which may be the diameter) of each of the guide members 112A, 112B is greater than a cross-sectional area and/or height (which may be the diameter) of an individual optical fiber 110. The guide members 112A, 112B and the optical fibers 110 may have circular cross sections in some embodiments, but these components may have other cross-sectional shapes in other embodiments.

The surface 101 defines a first area 107 (see FIG. 1C) between the first groove 104A and the second groove 104B. This first area 107 is provided without any grooves, and the first area 107 may serve as a flat substrate in some embodiments. Each optical fiber of the optical fibers 110 is positioned between the first guide member 112A and the second guide member 112B. Thus, the optical fibers 110 are positioned proximate to or in contact with the first area 107 of the surface 101, and the optical fibers 110 are effectively positioned relative to the fiber array unit 100 without the need for grooves in the fiber array unit 100 for the optical fibers 110. With the optical fibers 110 provided between the first guide member 112A and the second guide member 112B, the first guide member 112A and the second guide member 112B may effectively serve as sidewalls that assist in positioning the optical fibers 110 in the correct horizontal position. The first guide member 112A and the second guide member 112B may constrain the horizontal movement of the optical fibers 110. The first guide member 112A and the second guide member 112B may enable accurate passive optical alignment for optical fibers 110. By providing a fiber array unit 100 that is capable of effectively positioning optical fibers 110 without having grooves in the fiber array unit 100, the costs of manufacturing fiber array units 100 may be reduced.

In some embodiments, the first area 107 may define a flat plane so that the first area 107 may serve as a flat substrate. However, the first area 107 may possess different shapes in other embodiments. For example, the first area 107 of the surface 101 may be curved, contoured, or angled in other embodiments.

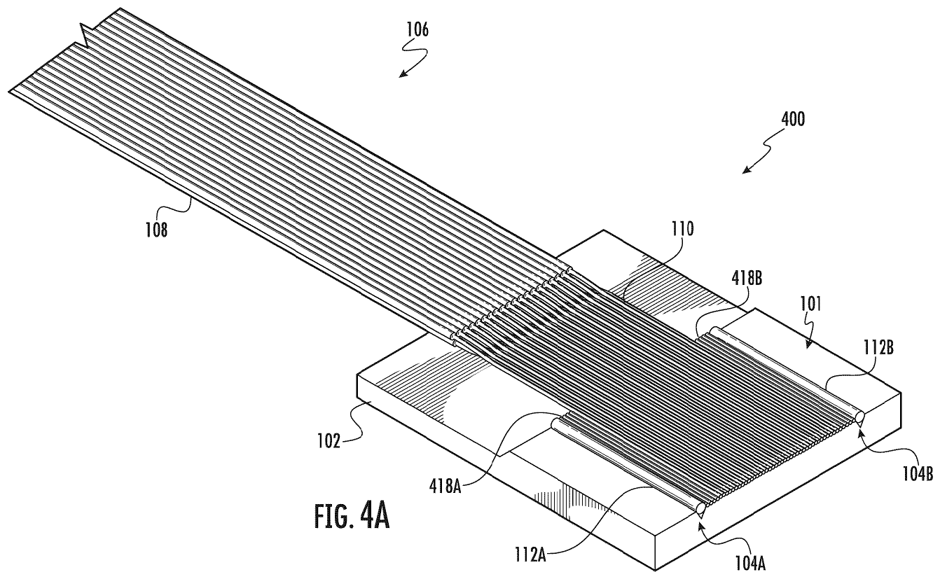

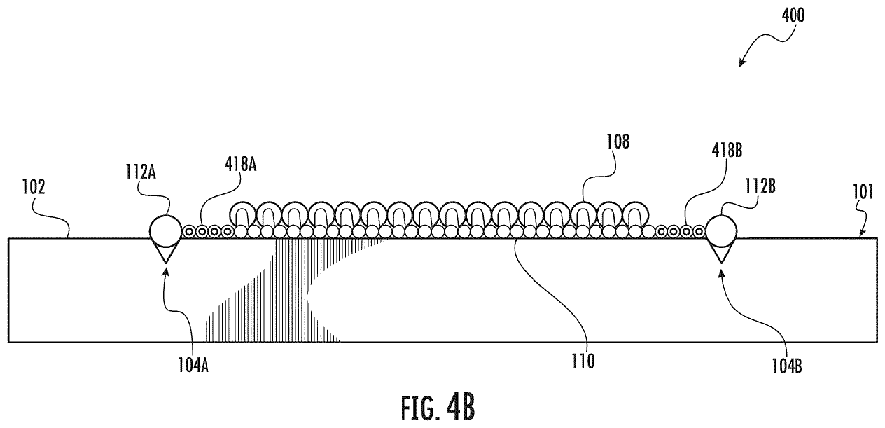

In some embodiments, optical fibers 110 and any dummy fibers 418A, 418B (see FIG. 4B) that are included may be fixed to the first area 107 either directly or indirectly. This may be accomplished in a variety of ways. For example, in FIG. 1C, optical fibers 110 are fixed to the first area 107 via adhesive. The adhesive is applied in gaps 103 formed between adjacent optical fibers 110 and the first area 107. FIG. 1D illustrates another embodiment where optical fibers 110 are fixed to the first area 107 through laser welding. Weld material 105 may be added by welding to assist in constraining movement of the optical fibers 110 relative to the fiber array structure 102.

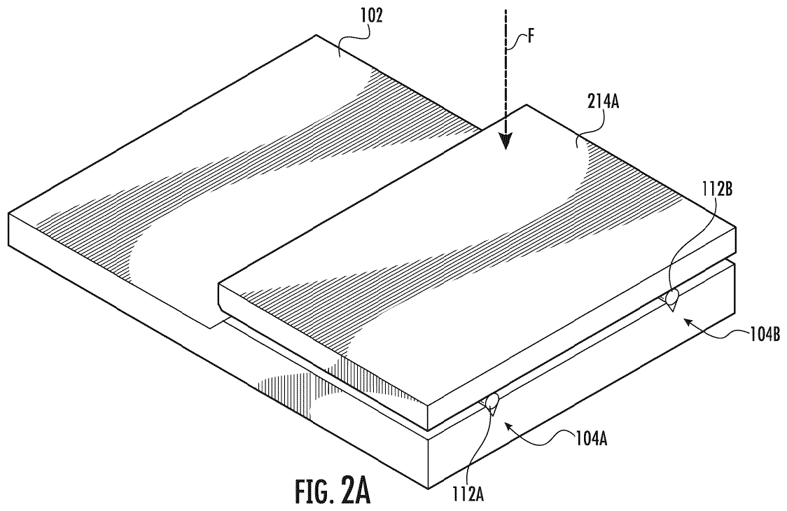

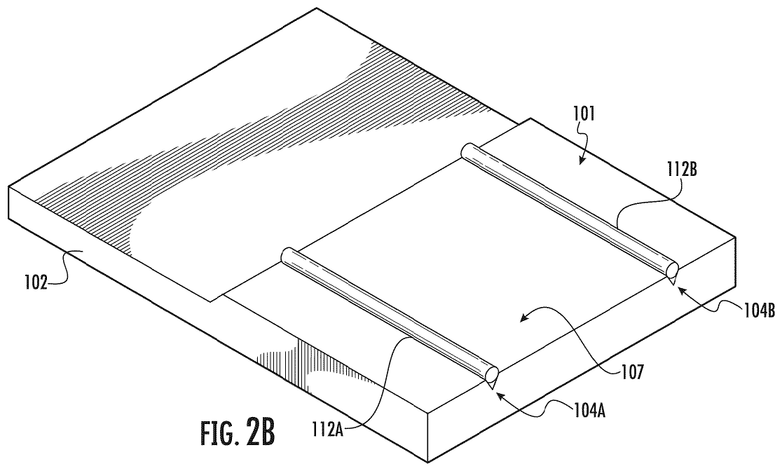

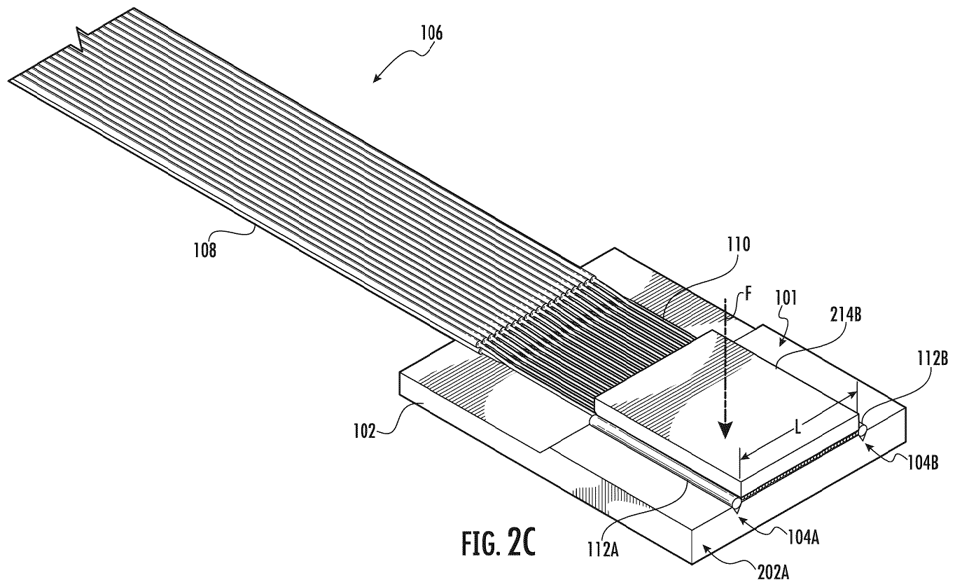

One or more fixtures may be utilized to assist in making a fiber array unit. The fixtures may be utilized to position guide members, optical fibers, and/or any dummy fibers appropriately. Where the guide members, optical fibers, and/or any dummy fibers are fixed to the fiber array structure, fixtures may retain these components in the appropriate position until fixation may be completed. FIGS. 2A-2C illustrate fixtures being used to assist at various stages in making a fiber array unit.

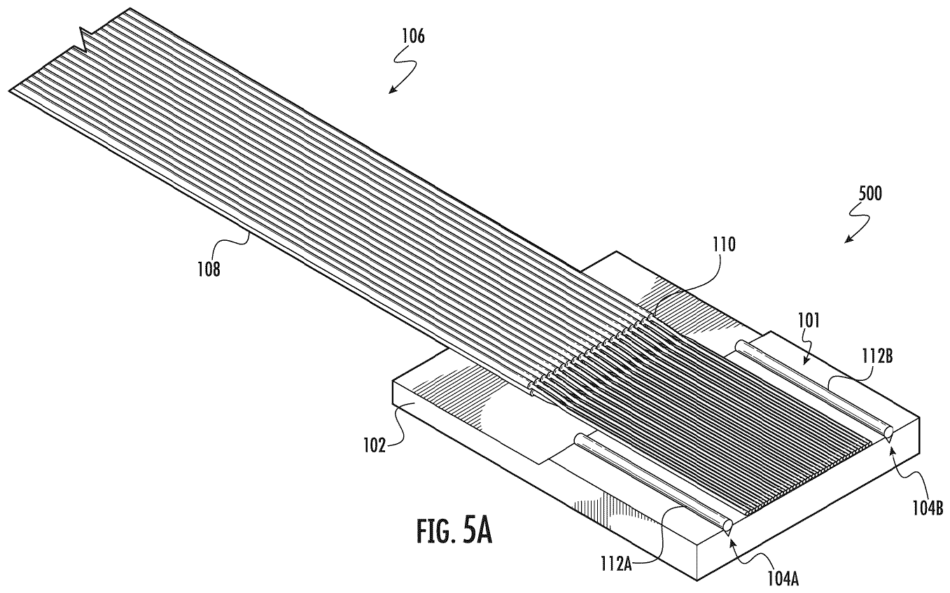

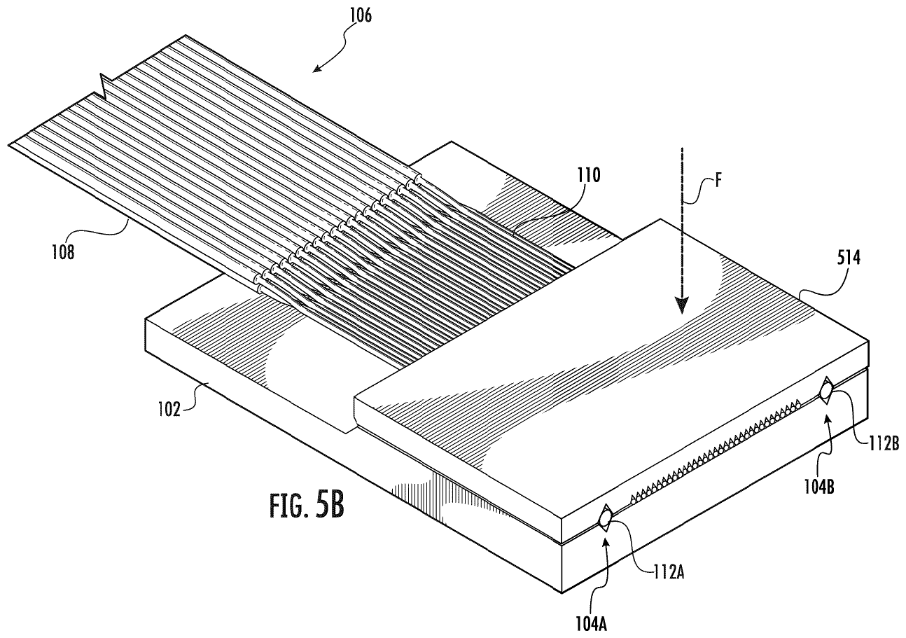

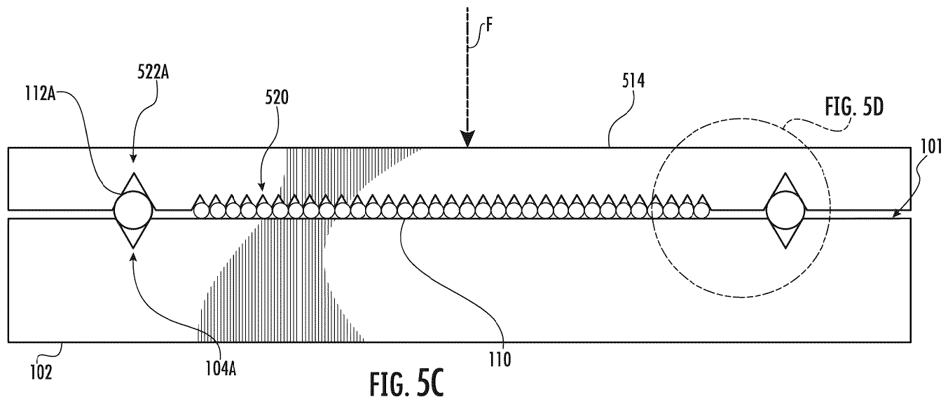

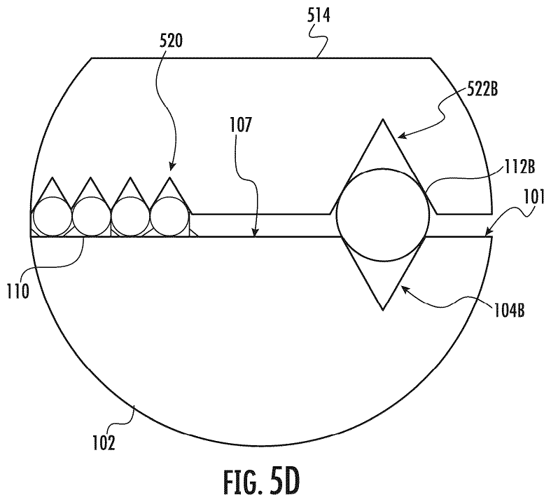

FIG. 2A is a perspective view illustrating a first example fixture being used to form an example fiber array unit. As illustrated, guide members are positioned in grooves of the fiber array structure 102. The first guide member 112A is positioned in the first groove 104A, and the second guide member 112B is positioned in the second groove 104B. As indicated by the downward arrow, a force (F) may be applied to the first fixture 214A, and the first fixture 214A may press the first guide member 112A and the second guide member 112B to the appropriate position as a result of this downward force (F). This force (F) may also cause the first guide member 112A and the second guide member 112B to be retained in the appropriate position. The first fixture 214A of FIG. 2A is provided without any grooves, but grooves may be defined within a surface of the first fixture 214A to assist in positioning of the guide members and/or the other fibers (see, e.g., fixture 514 of FIG. 5B). In some embodiments, the first guide member 112A may be fixed in the first groove 104A and the second guide member 112B may be fixed in the second groove 104B, and fixation of the guide members 112A, 112B may occur with the first fixture 214A being used to aid in controlling the position of the guide members 112A, 112B. The first fixture 214A may be removed as illustrated in FIG. 2B once the guide members 112A, 112B are appropriately positioned and/or fixed.

Looking now at FIG. 2C, a second fixture 214B is illustrated, with the second fixture 214B being utilized to aid in positioning the optical fibers 110. The second fixture 214B is sized so that the length between the edges of the first guide member 112A and the second guide member 112B is greater than or equal to the length (L) of the second fixture 214B. As indicated by the downward arrow, a force (F) is applied to the second fixture 214B, and the second fixture 214B urges the optical fibers 110 to the appropriate position as a result of this downward force (F). In this way, the second fixture 214B is urged downwardly without interference from the first guide member 112A or the second guide member 112B. However, in some embodiments, the second fixture 214B may possess a greater length. In some embodiments, the optical fibers 110 may be fixed relative to the fiber array structure 102, and fixation of the optical fibers 110 may occur with the second fixture 214B being used to aid in controlling the position of the optical fibers 110. The second fixture 214B may be removed once the optical fibers 110 are appropriately positioned and/or fixed.

In the embodiment illustrated in FIG. 2C, the first guide member 112A, the second guide member 112B, and the optical fibers 110 extend to the front surface 202A of the fiber array structure 102 but do not extend beyond the front surface 202A. In other embodiments, the guide members 112A, 112B and/or the optical fibers 110 may extend beyond the front surface 202A. For example, optical fibers 110 extend beyond the front surface 202A of the fiber array structure 102 but guide members 112A, 112B do not extend beyond the front surface 202A in FIGS. 3A and 3B. In FIG. 3C, guide members 112A, 112B extend beyond the front surface 202A of the fiber array structure 102 but optical fibers 110 do not extend beyond the front surface 202A. In FIG. 3D, guide members 112A, 112B and optical fibers 110 extend beyond the front surface 202A of the fiber array unit 300C.

The fiber array unit 300B of FIG. 3C includes guide members that extend beyond the front surface 202A. This feature may be beneficial to aid in alignment of the fiber array unit 300B with a ferrule or another optical coupling device to form an optical interconnect—the guide members may be configured to be received within slots or grooves provided in a ferrule or another optical coupling device, and this may aid in positioning the optical fibers 110 appropriately.

By providing the different approaches illustrated in FIG. 2C and FIGS. 3A-3D, a fiber array unit may be selected that is configured to work with different mating mechanisms. Where optical fibers 110 extend beyond the front surface 202A, the end face of the optical fibers 110 may be polished or laser cleaved to form an Ultra Physical Contact (UPC) fiber or an Angled Physical Contact (APC) fiber with a controlled surface roughness. Different roughness levels may be used at the end face of the optical fibers 110—for example, the end face may have an optical surface or the end face may have a rough surface. Where the first guide member 112A and/or the second guide member 112B extend beyond the front surface 202A, the end faces of these guide members may undergo similar end face processing.

Dummy fibers may be utilized in some embodiments to position the optical fibers as desired. Dummy fibers may be utilized to adjust the pitch between optical fibers, and the dummy fibers may also be configured to fill spaces left between guide members and optical fibers. FIGS. 4A-4B illustrate an example fiber array unit 400 where dummy fibers are used, with FIG. 4A providing a perspective view and with FIG. 4B providing a front view. Similar to the example fiber array unit 100 illustrated in FIG. 1A, the fiber array unit 400 of FIGS. 4A-4B includes a fiber array structure 102 defining a surface 101, with the surface 101 defining a first groove 104A and a second groove 104B. A first guide member 112A is positioned in the first groove 104A, and a second guide member 112B is positioned in the second groove 104B. Optical fibers 110 are also provided that are positioned between the first guide member 112A and the second guide member 112B.

In FIG. 1A, the optical fibers 110 extend in a single layer with the plurality of optical fibers 110 extending all the way from the first guide member 112A to the second guide member 112B, and the first guide member 112A and the second guide member 112B contact the optical fibers 110 to aid in controlling the position of the optical fibers 110. In FIGS. 4A-4B, the optical fibers 110 again extend in a single layer, but the optical fibers 110 do not extend all the way from the first guide member 112A to the second guide member 112B—instead, space is left between the optical fibers 110 and the first guide member 112A, and space is also left between the optical fibers 110 and the second guide member 112B. These spaces may arise where a different number of optical fibers 110 are being used. For example, the size of the spaces may be increased where sixteen optical fibers are used instead of thirty-two optical fibers and the length between the first groove 104A and the second groove 104B is left unchanged. The spaces may also arise where the length between the first groove 104A and the second groove 104B is changed, where the size and/or shape of the optical fibers 110 is changed, and/or also for other reasons.

Dummy fibers may be provided to fill in any spacing to aid in controlling the position of optical fibers. Regardless of the changes in length between the grooves, the number of optical fibers used, or other changes, the dummy fibers may be provided in variable amounts to fill in any spacing that is created between the optical fibers and the guide members. Thus, dummy fibers may be beneficial to adapt the fiber array unit to various use cases.

In FIG. 4A, a first set of dummy fibers 418A and a second set of dummy fibers 418B are provided. The first set of dummy fibers 418A may include just one dummy fiber, but the first set of dummy fibers 418A may include a plurality of dummy fibers as well. Similarly, the second set of dummy fibers 418B may include just one dummy fiber, but the second set of dummy fibers 418B may include a plurality of dummy fibers. The first set of dummy fibers 418A and the second set of dummy fibers 418B contact the first area 107.

The first set of dummy fibers 418A may fill in spaces left between the first guide member 112A and the optical fibers 110. A dummy fiber of the first set of dummy fibers 418A may contact the first guide member 112A, and the same dummy fiber or another dummy fiber of the first set of dummy fibers 418A may contact an optical fiber of the optical fibers 110, with the optical fiber being on a first end of the optical fibers 110. Similarly, the second set of dummy fibers 418B may fill in spaces left between the second guide member 112B and the optical fibers 110. A dummy fiber of the second set of dummy fibers 418B may contact the second guide member 112B, and the same dummy fiber or another dummy fiber of the second set of dummy fibers 418B may contact an optical fiber of the optical fibers 110, with the optical fiber being on a second end of the optical fibers 110.

In the illustrated embodiment of FIGS. 4A-4B, the first guide member 112A, the second guide member 112B, the dummy fibers of the first set of dummy fibers 418A, and the dummy fibers of the second set of dummy fibers 418B each have a circular cross-section. However, in other embodiments, some or all of these components may have other cross-sections—for example, some or all of these components may have a cross-sectional shape that is square, rectangular, trapezoidal, oval-shaped, asymmetrically shaped, or some other shape. Furthermore, in the illustrated embodiment of FIGS. 4A-4B, the first guide member 112A and the second guide member 112B possess a first cross-sectional area, and the optical fibers 110, the dummy fibers of the first set of dummy fibers 418A, the dummy fibers of the second set of dummy fibers 418B possess a second cross-sectional area. In some such example embodiments, the first cross-sectional area is greater than the second cross-sectional area. By providing the guide members having a larger cross-sectional area and/or larger height, the guide members may effectively serve as sidewalls to aid in positioning the optical fibers 110 and any dummy fibers. However, in other embodiments, the relative sizes of the optical fibers 110, dummy fibers, and guide members may be equal, or the guide members may actually have a smaller cross-sectional area than the optical fibers 110 and/or the dummy fibers.

Other example fiber array units may be provided where space is left between guide members and optical fibers, and the optical fibers may be effectively positioned without the use of dummy fibers. FIG. 5A illustrates a perspective view of such an example fiber array unit 500. A first guide member 112A, a second guide member 112B, and optical fibers 110 are provided. Spacing is left between the optical fibers 110 and the first guide member 112A, and spacing is also left between the optical fibers 110 and the second guide member 112B. The optical fibers 110 are fixed in position relative to the fiber array structure 102 (e.g. with adhesive or via laser welding).

FIGS. 5B, 5C, and 5D illustrate a fixture 514 being used to assist in forming the fiber array unit 500 of FIG. 5A. Unlike the fixture 214A of FIG. 2A and the fixture 214B of FIG. 2C, the fixture 514 of FIGS. 5B-5C includes grooves 520 that are configured to aid in the positioning of optical fibers 110. Each of the grooves 520 is configured to partially receive an optical fiber 110. Additionally, unlike the fixture 214A of FIG. 2A and the fixture 214B of FIG. 2C, the fixture 514 of FIGS. 5B-5C includes a first groove 522A and a second groove 522B that are configured to aid in the positioning of the fixture 514 relative to the first guide member 112A and the second guide member 112B. The first groove 522A is configured to partially receive the first guide member 112A, and the second groove 522B is configured to partially receive the second guide member 112B. The grooves 520 are provided between the first groove 522A and the second groove 522B. The grooves 520, the first groove 522A, and the second groove 522B are V-grooves in the illustrated embodiment. However, the grooves 520, 522A, 522B may have other shapes such as a rectilinear shape, a square shape, a circular shape, an oval shape, an asymmetrical shape, or some other shape.

As indicated by the downward arrow, a force (F) may be applied to the fixture 514, and the fixture 514 may urge the first guide member 112A, the second guide member 112B, and the optical fibers 110 to the appropriate position as a result of this force (F). In some embodiments, the fixture 514 may be used to retain the first guide member 112A, the second guide member 112B, and the optical fibers 110 in the appropriate position until these components are fixed to the fiber array structure 102.

While the grooves 520, the first groove 522A, and the second groove 522B are provided in the fixture 514 of FIGS. 5B through 5C, alternative embodiments of the fixture may only include grooves 520 without the first groove 522A or second groove 522B. Additionally, other alternative embodiments of the fixture may only include the first groove 522A and/or the second groove 522B, and the grooves 520 may not be provided.

In some embodiments, the fixture 514 may be removed after the first set of optical fibers 110 are positioned and/or fixed, resulting in the fiber array unit 500 illustrated in FIG. 5A. However, in other embodiments, the fixture 514 may be retained on the fiber array structure 102. Where the fixture 514 is retained, the fixture 514 may be fixed relative to the fiber array structure 102 after the first set of optical fibers 110 are positioned and/or fixed, and the fixture 514 may serve as a cover for the fibers and the guide members. Fixation of the fixture 514 may be performed in a variety of approaches—for example, the fixture 514 may be fixed through laser welding or through the use of adhesive.

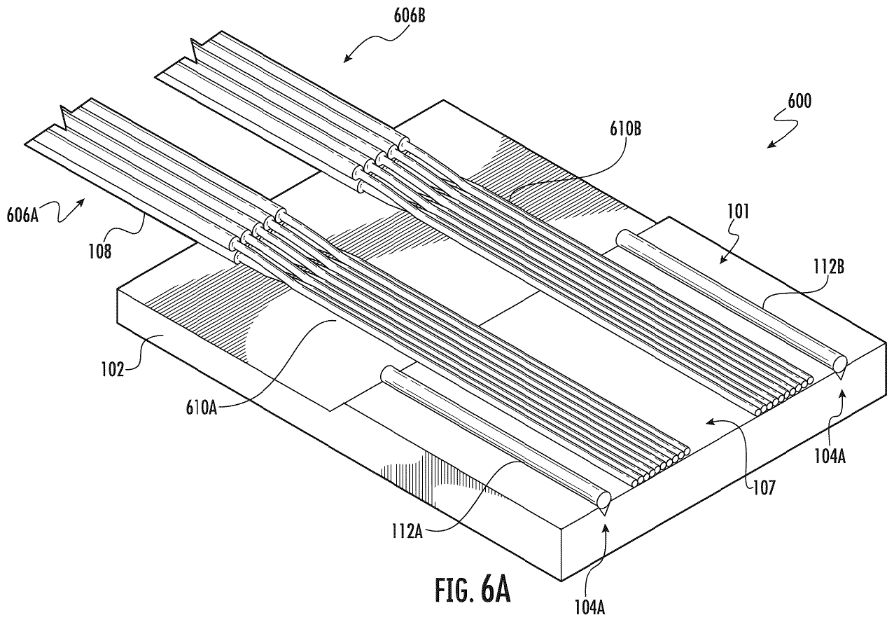

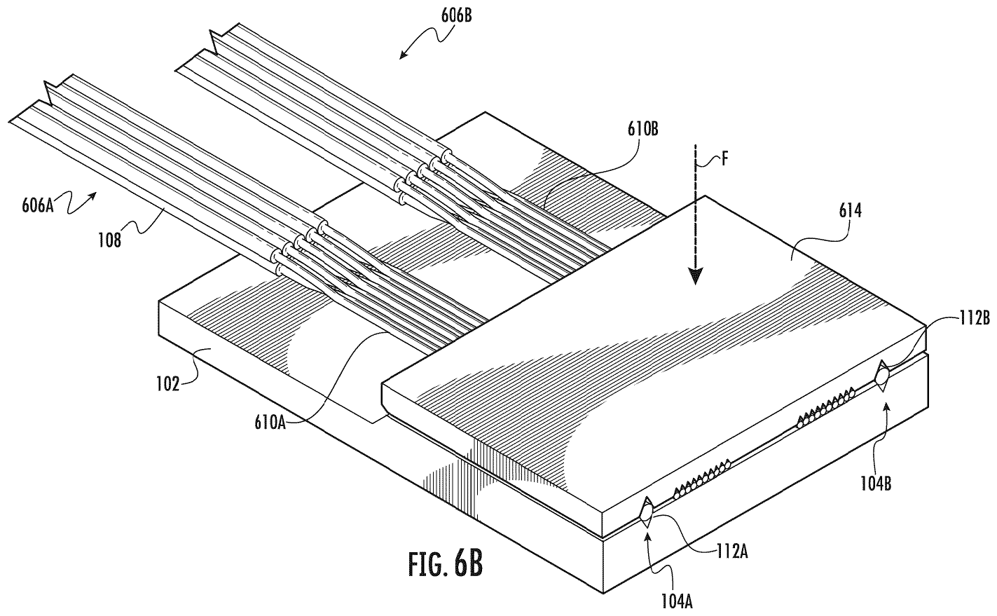

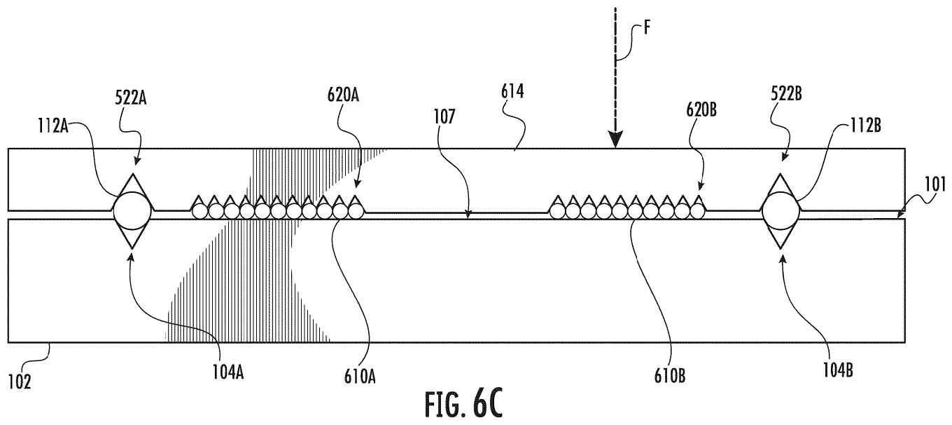

The fiber array units may be provided with spacing between different groups of optical fibers. FIGS. 6A-6C illustrate an example of such a fiber array unit 600, with FIG. 6A being a perspective view illustrating the fiber array unit 600, with FIG. 6B being a perspective view illustrating an example fixture 614 being used to assist in forming the fiber array unit 600, and with FIG. 6C being a front view illustrating the fixture 614 being used to assist in forming the fiber array unit 600.

Looking first at FIG. 6A, a fiber array unit 600 is provided with a first group of optical fibers 610A and a second group of optical fibers 610B. The first group of optical fibers 610A may extend from a first group of covered optical fibers 606A, and the second group of optical fibers 610B may extend from a second group of covered optical fibers 606B. A space may be retained between the first group of optical fibers 610A and the second group of optical fibers 610B.

This spacing and the positioning of the optical fibers illustrated in FIG. 6A may be accomplished using the fixture 614 illustrated in FIGS. 6B-6C. As illustrated in FIG. 6C, the fixture 614 includes a first groove 522A and a second groove 522B. The first groove 522A is configured to partially receive the first guide member 112A to assist in positioning the fixture 614, and the second groove 522B is configured to partially receive the second guide member 112B to assist in positioning the fixture 614. The fixture 614 also includes a first set of grooves 620A and a second set of grooves 620B. The first set of grooves 620A are configured to partially receive the first group of optical fibers 610A to assist in positioning and/or fixing the first group of optical fibers 610A, and the second set of grooves 620B are configured to partially receive the second group of optical fibers 610B to assist in positioning and/or fixing the second group of optical fibers 610B. While the various grooves are provided at particular locations in the embodiment illustrated in FIG. 6C, the grooves may be provided at other locations in other embodiments so that the optical fibers may be positioned differently. The first set of grooves 620A and the second set of grooves 620B may assist in controlling the pitch between optical fibers and the distance between optical fibers and guide members.

The spacing and positioning of optical fibers illustrated in FIG. 6A may be accomplished through the use of dummy fibers in other embodiments, with dummy fibers provided in spaces between the first guide member 112A and the first group of optical fibers 610A, between the first group of optical fibers 610A and the second group of optical fibers 610B, and/or between the second group of optical fibers 610B and the second guide member 112B. Dummy fibers may be removed from the fiber array unit once the optical fibers are positioned and/or fixed in some embodiments, but dummy fibers may be retained as part of the fiber array unit in other embodiments.

As indicated by the downward arrow in FIGS. 6B-6C, a force (F) may be applied to the fixture 614, and the fixture 614 may urge the first guide member 112A, the second guide member 112B, and the optical fibers to the appropriate position as a result of this downward force (F). In some embodiments, the fixture 614 may be used to retain the first guide member 112A, the second guide member 112B, and the optical fibers in the appropriate position until these components are fixed to the fiber array structure 102.

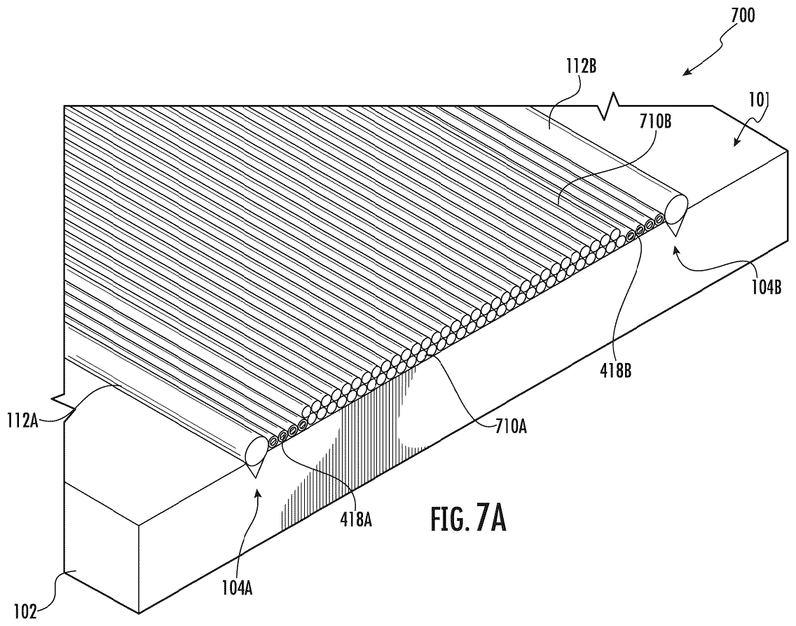

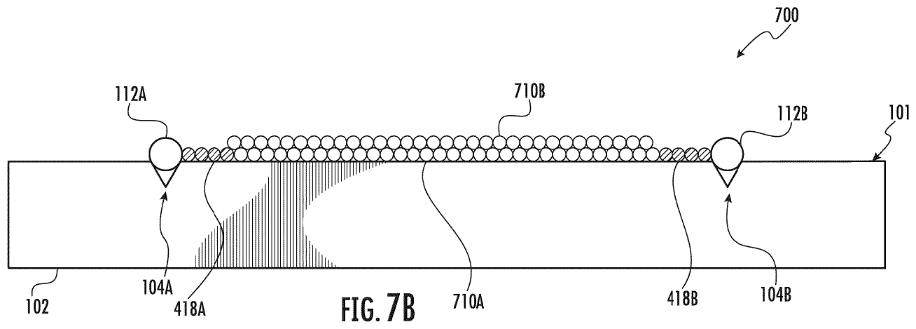

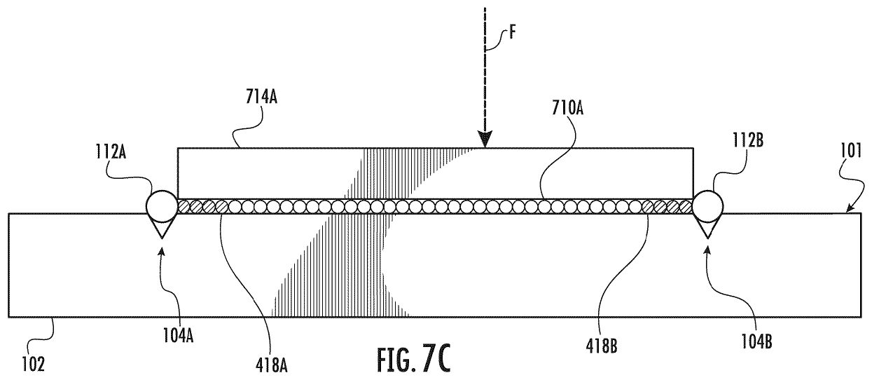

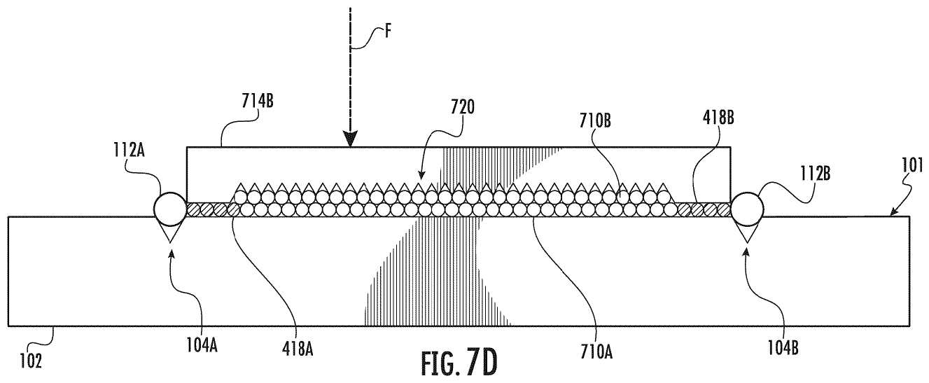

Optical fibers may be stacked in multiple layers in the fiber array unit in some embodiments. FIGS. 7A-7B illustrate such an example fiber array unit 700, with FIG. 7A providing a perspective view and with FIG. 7B providing a front view. In the fiber array unit 700, a first layer may be formed by a first set of optical fibers 710A and dummy fibers. The first set of optical fibers 710A is provided between the first guide member 112A and the second guide member 112B. A first set of dummy fibers 418A is provided in the first layer between the first set of optical fibers 710A and the first guide member 112A, and a second set of dummy fibers 418B is provided in the first layer between the first set of optical fibers 710A and the second guide member 112B. However, in other embodiments, the first layer may be provided without any dummy fibers. Thirty-two optical fibers are provided in the first set of optical fibers 710A and four dummy fibers are provided in each of the first set of dummy fibers 418A and the second set of dummy fibers 418B, but the number of optical fibers and dummy fibers may be varied in other embodiments. The first guide member 112A and the second guide member 112B may act as sidewalls, with these guide members each contacting a dummy fiber to provide constraints on the horizontal movement of the dummy fibers and the first set of optical fibers 710A.

A second layer may be provided above the first layer. In the example fiber array unit 700 of FIGS. 7A-7B, the second layer simply includes a second set of optical fibers 710B. Thirty-two optical fibers are provided in the second set of optical fibers 710B, but the number of optical fibers may be varied in other embodiments. The second layer may also include dummy fibers in some embodiments. The second layer may be provided so that the first set of optical fibers 710A is positioned vertically between the second set of optical fibers 710B and the first area 107 of the fiber array structure 102. Furthermore, the optical fibers may be provided in each layer so that they contact one or more optical fibers in another layer, and each optical fiber of the second set of optical fibers 710B may contact another optical fiber of the first set of optical fibers 710A.

The fibers in each layer may be stacked in a staggered manner. For example, the optical fibers of the second set of optical fibers 710B sink down in gaps formed between adjacent fibers in the first layer. Thus, the optical fibers of the second set of optical fibers 710B may sink down until they come in contact with two fibers from the first layer of fibers. Most of the optical fibers of the second set of optical fibers 710B are in contact with two optical fibers of the first set of optical fibers 710A. However, in the illustrated embodiment, the left-most optical fiber in the second set of optical fibers 710B is in contact with only one optical fiber of the first set of optical fibers 710A as that left-most optical fiber also comes in contact with a dummy fiber. By stacking the fibers in a staggered manner, the optical fiber density in the fiber array unit 700 may be increased.

Additionally, fixtures may be utilized to assist in positioning the layers of fibers to form the fiber array unit 700 of FIG. 7A. FIG. 7C provides a front view illustrating a first example fixture 714A being used to assist in forming the fiber array unit 700 of FIG. 7A. The first set of optical fibers 710A may be placed between the first guide member 112A and the second guide member 112B, and the first set of dummy fibers 418A and the second set of dummy fibers 418B may also be placed in the desired positions between the guide members to aid in controlling the position of the first set of optical fibers 710A. With the optical fibers and dummy fibers placed, the first fixture 714A may be utilized to aid in positioning the fibers. A downward force (F) may be applied on the first fixture 714A to generate a downward force on the fibers below. As illustrated, the first fixture 714A is provided without any grooves on the bottom surface of the first fixture 714A, but grooves may be provided at this bottom surface in other embodiments as a further measure to aid in positioning the fibers. With the first fixture 714A in place, the first set of optical fibers 710A and/or any dummy fibers may be fixed to the fiber array structure 102. Once these fibers have been fixed, the first fixture 714A may be removed to allow additional layers of fibers to be added.

FIG. 7D is a front view illustrating a second example fixture 714B being used to assist in forming the fiber array unit of FIG. 7A. This second fixture 714B is utilized to effectively position a second layer of fibers. This second layer of fibers includes a second set of optical fibers 710B in the illustrated embodiment. The second fixture 714B includes a plurality of grooves 720 on the bottom surface of the second fixture 714B. An appropriate number of grooves may be provided to permit each of the fibers in the second layer to have a corresponding groove. In the embodiment illustrated in FIG. 7D, thirty-two optical fibers are provided in the second layer, so thirty-two grooves 720 are provided in the second fixture 714B. While grooves 720 are provided in the second fixture 714B in the illustrated embodiment, other fixtures not having grooves may be utilized to aid in positioning the second layer in other embodiments. In some embodiments, rather than positioning a second layer using a second fixture 714B that is different from the first fixture 714A, the first fixture 714A may instead be used to position multiple layers of fibers.

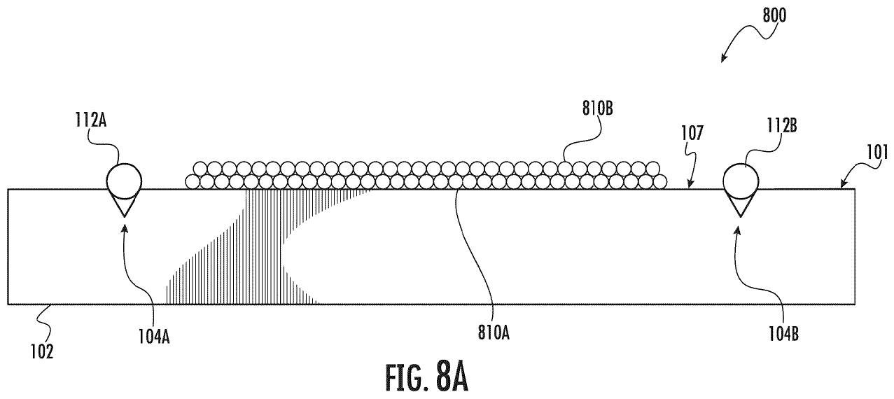

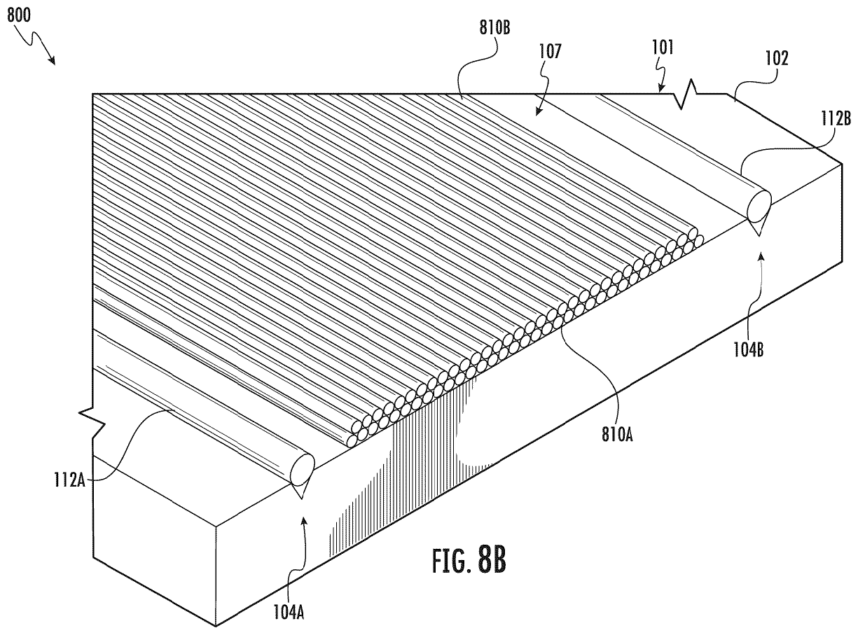

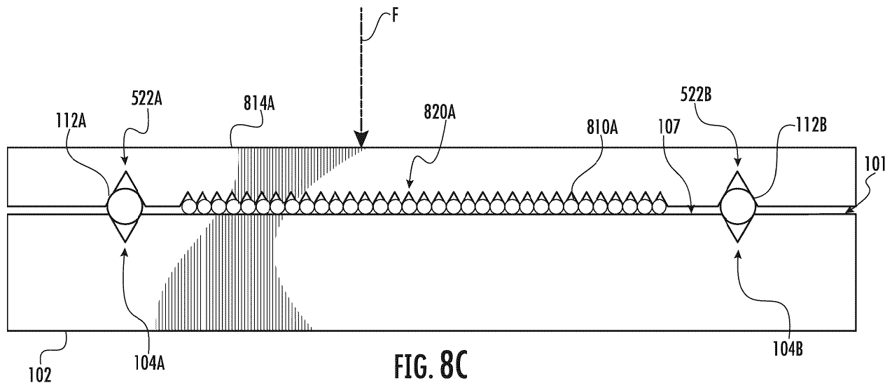

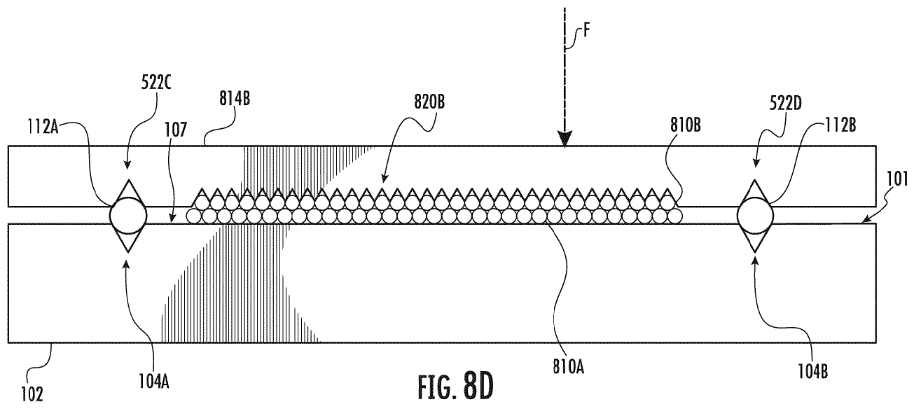

Other fiber array units having optical fibers in multiple layers may be provided. FIGS. 8A-8B illustrate an example of one alternative fiber array unit 800, with FIG. 8A providing a front view and with FIG. 8B providing a perspective view. In the fiber array unit 800, a first layer of fibers is provided without any dummy fibers. The first layer of fibers consists solely of a first set of optical fibers 810A, with thirty-three optical fibers being provided in this first layer. The second layer of fibers also consists solely of a second set of optical fibers 810B, with thirty-two optical fibers being provided in this second layer. The first set of optical fibers 810A of the first layer are positioned vertically between the first area 107 and the second set of optical fibers 810B.

The layers may be stacked in a staggered manner. Fibers of the second layer may sink into gaps between adjacent fibers in the first layer so that each fiber of the second layer comes in contact with two fibers of the first layer. By stacking the fibers in this manner, the density of optical fibers in the fiber array unit 800 may be increased.

FIG. 8C is a front view illustrating a first example fixture 814A being used to assist in forming the fiber array unit 800 of FIG. 8A. The first fixture 814A may be utilized to assist in positioning the first set of optical fibers 810A that form the first layer. The first fixture 814A includes a plurality of grooves 820A in the bottom surface of the first fixture 814A. The number of grooves 820A provided may correspond to the number of optical fibers provided in the first set of optical fibers 810A. In the illustrated embodiment, thirty-three optical fibers are provided in the first set of optical fibers 810A, and thirty-three grooves 820A are provided in the first fixture 814A. The grooves 820A may help control the position of the optical fibers and may control the pitch between adjacent optical fibers. The first fixture 814A may be utilized to assist in positioning the optical fibers of the first set of optical fibers 810A, and the first fixture 814A may be held in place until these optical fibers are fixed relative to the fiber array structure 102. Once these optical fibers are fixed, the first fixture 814A may be removed so that additional layers of fibers may be added.

Looking now at FIG. 8D, a front view is provided illustrating a second example fixture 814B being used to assist in forming the fiber array unit 800 of FIG. 8A. The second fixture 814B may be utilized to assist in positioning the second set of optical fibers 810B that form the second layer. The second fixture 814B includes a plurality of grooves 820B in the bottom surface of the second fixture 814B. The number of grooves 820B provided may correspond to the number of optical fibers provided in the second set of optical fibers 810B. In the illustrated embodiment, thirty-two optical fibers are provided in the second set of optical fibers 810B, and thirty-two grooves 820B are provided in the second fixture 814B. The second fixture 814B may be utilized to assist in positioning the optical fibers of the second set of optical fibers 810B, and the second fixture 814B may be held in place until these optical fibers are fixed relative to the fiber array structure 102. The second set of optical fibers 810B may be fixed relative to the fiber array structure 102 by fixing the second set of optical fibers 810B directly to the first set of optical fibers 810A, which may already be fixed directly to the fiber array structure 102. Once the second set of optical fibers 810B are fixed relative to the fiber array structure 102, the second fixture 814B may be removed so that additional layers of fibers may be added (if any). Alternatively, the second fixture 814B may be retained and/or fixed to the fiber array structure 102.

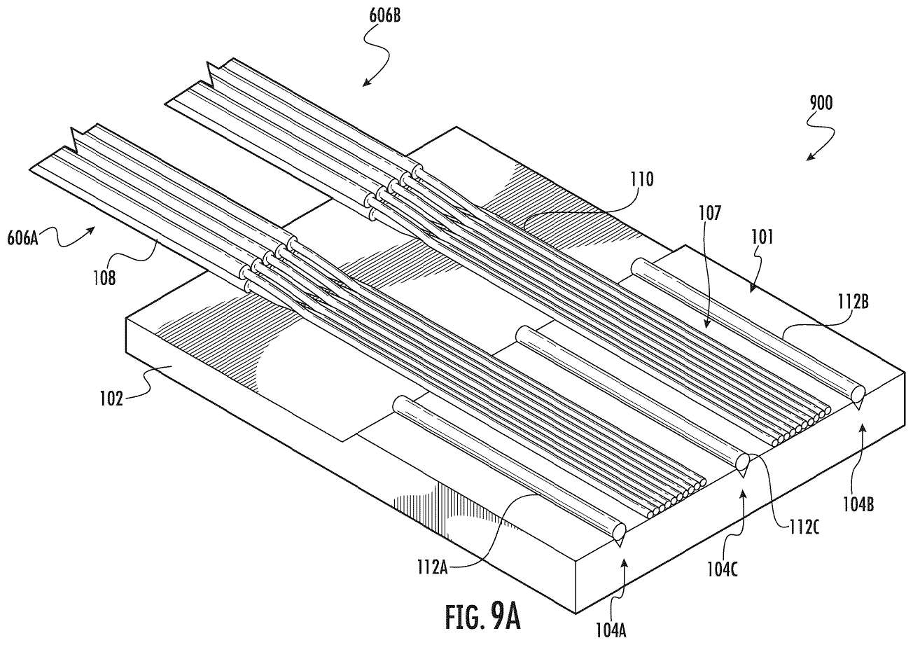

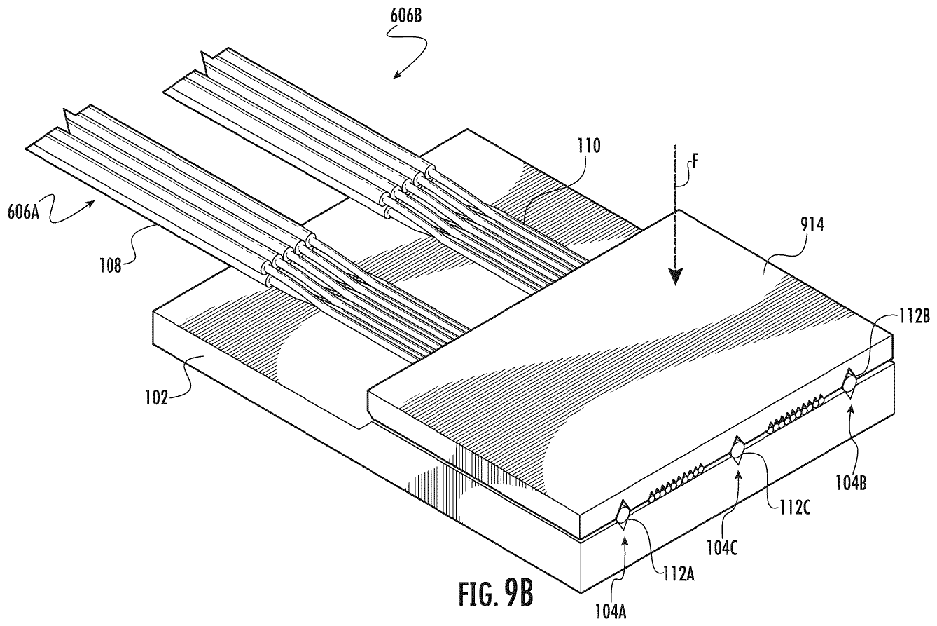

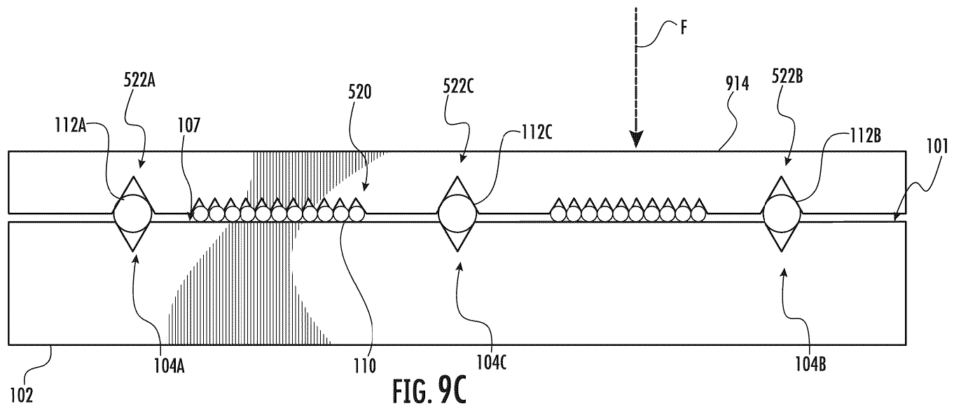

Three or more guide members may be provided in some fiber array units to further aid in controlling the position of fibers. FIG. 9A is a perspective view illustrating an example fiber array unit 900 where three guide members are used. Furthermore, FIGS. 9B and 9C illustrate an example fixture 914 being used to assist in forming the fiber array unit 900 of FIG. 9A, with FIG. 9B providing a perspective view and FIG. 9C providing a front view. As illustrated in FIGS. 9A-9C, the fiber array structure 102 may include a first groove 104A, a second groove 104B, and a third groove 104C. Furthermore, as illustrated in FIG. 9C, the fixture 914 may include a first groove 522A, a second groove 522B, and a third groove 522C. The fiber array unit 900 may also include a first guide member 112A, a second guide member 112B, and a third guide member 112C.

Each of the guide members are partially received in a respective groove of the fiber array structure 102 and another respective groove of the fixture 914. The first guide member 112A is partially received in the first groove 104A of the fiber array structure 102, and the first guide member 112A is also partially received in the first groove 522A of the fixture 914. The second guide member 112B is partially received in the second groove 104B of the fiber array structure 102, and the second guide member 112B is also partially received in the second groove 522B of the fixture 914. The third guide member 112C is partially received in the third groove 104C of the fiber array structure 102, and the third guide member 112C is also partially received in the third groove 522C of the fixture 914.

The inclusion of additional guide members may be beneficial to further control the position of the optical fibers 110 in the fiber array unit 900. Inclusion of three or more guide members may also be beneficial to limit the amount of force that is applied on each individual optical fiber 110 when any downward force (F) is applied to the fixture 914.

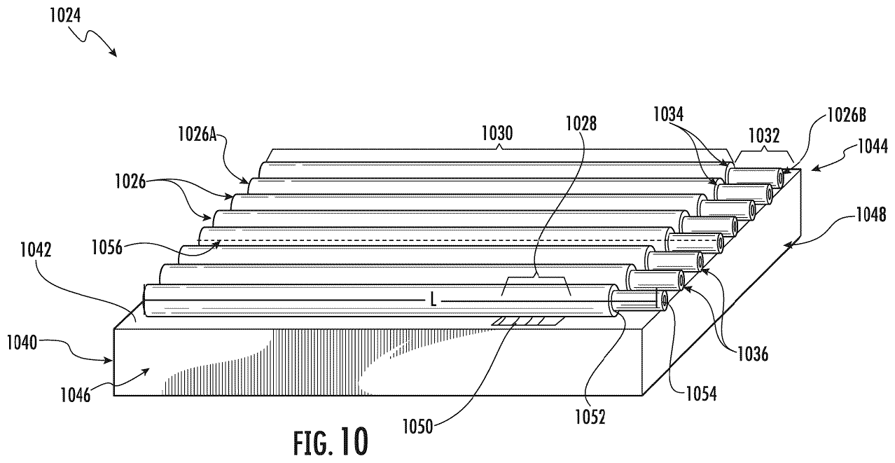

In some embodiments, optical fibers provided in a fiber array unit may be formed by two or more distinct optical fibers that are spliced together. FIG. 10 illustrates an example of one such fiber array unit 1024, having an optical fiber 1026 disposed on a film 1050 positioned on a surface 1042 of a fiber array structure 1040. The optical fiber 1026 may be laser welded to the surface 1042 of the fiber array structure 1040 by directing heat towards the film 1050. In some embodiments, other bonding methods may be used to weld the optical fiber 1026 on to the surface 1042 of the substrate. Notably, the optical fiber 1026 may be laser welded to the fiber array structure with methods as disclosed within U.S. Pat. No. 10,345,533, entitled “Assemblies, Optical Connectors and Methods of Bonding Optical Fibers to Substrates”, filed Feb. 15, 2018; U.S. Pat. No. 10,422,961, entitled “Fiber Array Formed Using Laser Bonded Optical Fibers”, filed Feb. [symbol] Oct. 11, 2018; U.S. Pat. No. 10,545,293, entitled “Assemblies, Optical Connectors and Methods of Bonding Optical Fibers to Substrates”, filed May 13, 2019; and U.S. Pat. No. 10,746,937, entitled “Assemblies, Optical Connectors and Methods of Bonding Optical Elements to Substrates”, filed Oct. 25, 2019, which are assigned to the Assignee and Applicant of this application, and which are each incorporated by reference herein in their entireties.

The optical fiber 1026, may define a length L extending between a first end 1026A and a second end 1026B, with the second end 1026B being a cut end. An optical pathway 1056 may extend along the length L of the optical fiber 1026. The optical pathway 1056 may be configured such that the length L of the optical fiber 1026 defines an output characteristic of optical signals extending from the second end 1026B of the optical fiber 1026, and thereby the optical pathway 1056. The optical pathway 1056 may extend through a core 1036 of the optical fiber 1026, and cladding may surround the core 1036 of the optical fiber 1026. The cladding may contribute to the refractive characteristics of the optical fiber 1026.

In some embodiments, the length L of the at least one optical fiber 1026 may determine output characteristics of the optical fiber 1026. In this regard, a portion of the optical fiber 1026 may define an optical variation portion where the output characteristics of output signals vary depending on the position along the optical variation portion. By positioning the second end 1026B at different positions along the optical variation portion, different output characteristics may be obtained (e.g., choosing where to position the second end 1026B allows for customized output characteristics). The output characteristics may be, for example, focusing, collimating, and/or diverging characteristics of a ray and/or beam propagating within the optical fiber 1026.

The second end 1026B may be provided in a variety of positions relative to the end face 1048 of the fiber array structure 1040. The second end 1026B of the optical fiber 1026 is aligned with an end face 1048 of the fiber array structure 1040 in FIG. 10. In some embodiments, the second end 1026B of the optical fiber 1026 may be recessed from an end face 1048 of the fiber array structure 1040, or the second end 1026B may extend past the end face 1048.

The second end 1026B may be inserted into a ferrule, a v-groove or other optical coupling device to transfer and transmit data and optical information between the optical fiber 1026 and another device. In some embodiments, the second end 1026B of the optical fiber 1026 may be recessed from the end face of a ferrule, a v-groove or other optical coupling device to transfer and transmit data and optical information between the optical fiber 1026 and another device.

In some embodiments, as illustrated in FIG. 10, the optical fiber 1026 may be formed from a first optical fiber 1030 and a second optical fiber 1032 spliced together at a splice position 1034. The core of the first optical fiber 1030 may be surrounded by cladding 1052 that may contribute to the refractive characteristics of the first optical fiber 1030, and the core of the second optical fiber 1032 may be surrounded by cladding 1054 that may contribute to the refractive characteristics of the second optical fiber 1032. In some embodiments, a fiber length of the second optical fiber 1032 extending between the splice position 1034 and the second end 1026B may define the output characteristics of the optical fiber 1026.

In some embodiments, the film 1050 is disposed under a portion 1028 of the first optical fiber 1030, and the second end 1026B is on the second optical fiber 1032. In some embodiments, the portion 1028 of the optical fiber may extend across the surface 1042 of the fiber array structure 1040, while in other embodiments, the portion 1028 may extend partially across the surface 1042 of the fiber array structure 1040.

In some embodiments, the optical fibers 1026 are in an 8 optical fiber ribbon positioned on the surface 1042 of the fiber array structure 1040, wherein the optical fibers 1026 extend from a first side 1046 of the fiber array structure 1040 to a second side 1044 of the fiber array structure 1040. In some embodiments, optical fibers 1026 in the fiber ribbon may extend from the first side 1046 to the second side 1044 of the fiber array structure 1040, while in other embodiments, the optical fibers 1026 within the fiber ribbon may extend partially between the first side 1046 and the second side 1044.

In some embodiments, the optical fibers 1026 may be ribbonized (e.g., adhered to one another), either in a flat configuration or in a rollable configuration wherein the optical fibers 1026 are intermittently bonded.

In some embodiments, the first optical fiber 1030 may be a single mode fiber. The single mode fiber supports only one linearly-polarized (LPO1) mode per polarization direction at the system wavelength. In some embodiments, the first optical fiber 1030 may have a low bend-loss, for example less than 1 decibel when wrapped around a 25 millimeter diameter mandrel, less than 1 decibel when wrapped around a 20 millimeter diameter mandrel and, more preferably, less than 1 decibel when wrapped around a 15 millimeter diameter mandrel. In some embodiments, the first optical fiber 1030 may comprise a step-index core. In some embodiments, the first optical fiber 1030 may comprise a rounded-step index core. In some embodiments, the first optical fiber 1030 may comprise a core having an alpha value greater than 10. In some embodiments, the first optical fiber 1030 may comprise a gradient-index core. In some embodiments, the first optical fiber 1030 may comprise a core having an alpha value less than 10. In some embodiments, the first optical fiber 1030 may comprise a 22 meter cutoff wavelength of less than 1260 nanometers, less than 1230 nanometers or more preferably less than 1200 nanometers. In some embodiments, the first optical fiber 1030 may comprise a 2 meter cutoff wavelength of less than 1260 nanometers, less than 1230 nanometers or more preferably less than 1200 nanometers.

In some embodiments, the second optical fiber 1032 is a multimode fiber (MMF), wherein the MMF may support more than one linearly-polarized mode at the system wavelength. More specifically, in some embodiments, the second optical fiber 1032 is configured as a MMF gradient-index (GRIN) lens, which allows for multiple rays to propagate within the core 1036. In some embodiments, the second optical fiber 1032 may have a parabolic gradient-index profile (e.g., the curvature of the core, α=2), while in other embodiments the curvature of the core of the MMF GRIN lens may not be parabolic (e.g., the curvature of the core, α does not equal 2). In some embodiments, the second optical fiber 1032 may have a core 1036. The core 1036 may have a 25 micron, 50 micron, 62.5 micron or a 100 micron diameter. In some embodiments, the gradient-index profile may define a core curvature value of 1.80>α>2.20.

Methods of making the fiber array units are also contemplated, and FIG. 11 is a flow chart illustrating one example method 1100 of making a fiber array unit. At operation 1102, a first set of optical fibers, a first guide member, and a second guide member are provided. Furthermore, at operation 1102, a fiber array structure is provided. The fiber array structure has a surface. This surface defines a first groove and a second groove, and the surface defines a first area between the first groove and the second groove. This first area is provided without any grooves. Dummy fibers may also be provided at operation 1102.

At operation 1104, the guide members are positioned in grooves of the fiber array structure. The first guide member is positioned in the first groove, and the second guide member is positioned in the second groove. At operation 1106, the first guide member and the second guide member may be pressed in their respective grooves using a fixture. By doing so, the positioning of the first guide member and the second guide member may be further improved.

At operation 1108, the guide members are fixed in the grooves, with the first guide member fixed at the first groove and with the second guide member fixed at the second groove. The guide members may be fixed using laser welding or adhesives, but other approaches for fixing the guide members may also be utilized. The fixture utilized at operation 1106 may continue to be used to press guide members in grooves while operation 1108 is executed, and the fixture is removed at operation 1110.

At operation 1112, the first set of optical fibers are positioned so that each optical fiber of the first set of optical fibers contacts the first area so as to be positioned between the first guide member and the second guide member. Where dummy fibers are utilized, dummy fibers may be positioned between the first guide member and the second guide member at operation 1114.

At operation 1116, the first set of optical fibers and any dummy fibers are pressed into position using a fixture. The fixture utilized at operation 1116 may be the same fixture as the fixture utilized at operation 1106 in some embodiments, but different fixtures may be utilized at these operations in other embodiments.

At operation 1118, the first set of optical fibers are fixed relative to the fiber array structure. To the extent that dummy fibers are utilized, these dummy fibers may also be fixed relative to the fiber array structure at operation 1118. The first set of optical fibers and any dummy fibers may be fixed in a variety of ways. In some example embodiments, laser welding or adhesives may be utilized to fix the first set of optical fibers and any dummy fibers.

The fixture utilized at operation 1116 may continue to be used to press the first set of optical fibers and any dummy fibers in grooves while operation 1118 is executed, and the fixture is removed at operation 1120. At operation 1120, the fixture utilized at operation 1116 may be removed. Further, at operation 1122, a cover may be added (although the cover may be optional in some embodiments). However, in some embodiments, the fixture utilized at operation 1116 may not be removed, and the fixture may serve as a cover.

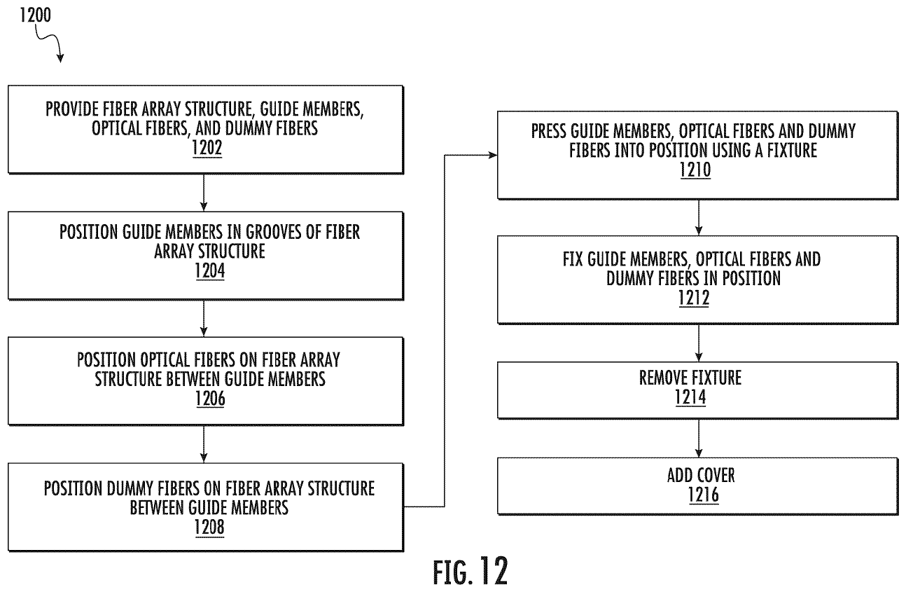

FIG. 12 is a flow chart illustrating another example method 1200 of making a fiber array unit. In the method 1200 of FIG. 12, a fixture is utilized to press guide members, optical fibers, and any dummy fibers into position simultaneously.

At operation 1202, a first set of optical fibers, a first guide member, and a second guide member are provided. Furthermore, at operation 1202, a fiber array structure is provided. The fiber array structure has a surface. This surface defines a first groove and a second groove, and the surface defines a first area between the first groove and the second groove. This first area is provided without any grooves. Dummy fibers may also be provided at operation 1202.

At operation 1204, the guide members are positioned in grooves of the fiber array structure. The first guide member is positioned in the first groove, and the second guide member is positioned in the second groove.

At operation 1206, the first set of optical fibers may be positioned so that each optical fiber of the first set of optical fibers contacts the first area so as to be positioned between the first guide member and the second guide member.

At operation 1208, dummy fibers may be provided and may be positioned between the first guide member and the second guide member. The dummy fibers may aid in controlling the position of the optical fibers as discussed herein.

At operation 1210, a fixture may be utilized to press the first guide member, the second guide member, the first set of optical fibers, and the dummy fibers into position.

At operation 1212, the first guide member, the second guide member, the first set of optical fibers, and the dummy fibers may be fixed in position. The guide members may be fixed in the grooves, with the first guide member fixed at the first groove and with the second guide member fixed at the second groove. The guide members, the optical fibers, and the dummy fibers may be fixed using laser welding or adhesives, but other approaches for fixing the guide members may also be utilized.

At operation 1214, the fixture may be removed. At operation 1216, a cover may be added (although the cover may be optional in some embodiments). However, in some embodiments, the fixture may not be removed at operation 1214, and the fixture may effectively serve as a cover. In such an embodiment, the fixture may be fixed in position relative to the fiber array structure at operation 1212.

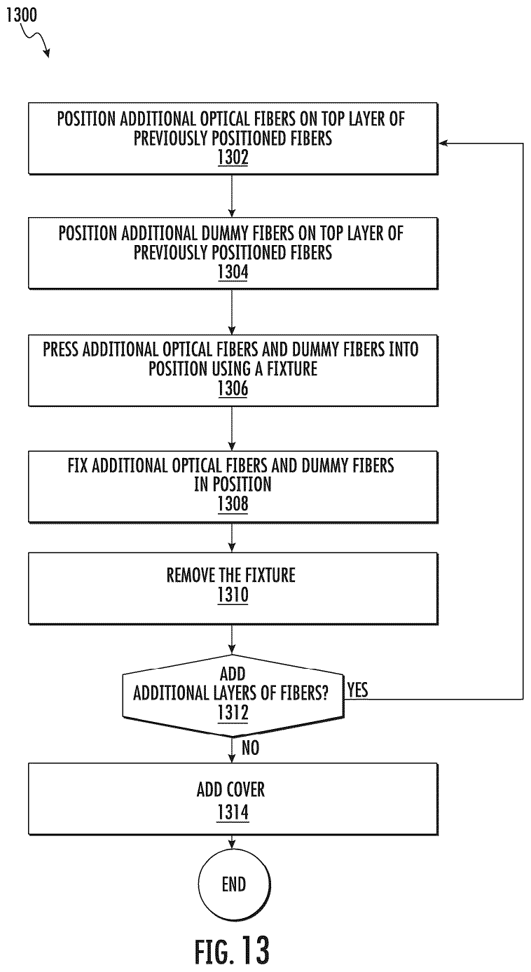

In some embodiments, additional layer(s) of fibers may be added to the fiber array units created by the method 1100 of FIG. 11 or the method 1200 of FIG. 12. The method 1100 of FIG. 11 or the method 1200 of FIG. 12 may be utilized to provide a fiber array unit having a single layer of optical fibers. The method 1300 of FIG. 13 may be executed after performing the method 1100 of FIG. 11 or the method 1200 of FIG. 12, and the method 1300 may be utilized to add additional layer(s) of fibers to the fiber array unit. As illustrated, the method 1300 may be performed iteratively to provide additional layers of fibers until the desired number of layers have been included.

At operation 1302, additional optical fibers are positioned on the top layer of previously positioned fibers. The additional optical fibers may be a second set of optical fibers, but the additional optical fibers may be a third set of optical fibers or a further set of optical fibers. Furthermore, at operation 1304, additional dummy fibers may be positioned on the top layer of the previously positioned fibers. The previously positioned fibers include the first set of optical fibers, and the previously positioned fibers may also include dummy fibers. In some embodiments, the additional optical fibers may be positioned such that the previously positioned fibers are positioned vertically between the first area and the additional optical fibers. In some embodiments, the additional optical fibers and additional dummy fibers may be positioned at operations 1302 and 1304 such that these fibers rest in gaps between two adjacent fibers of the top layer of previously positioned fibers. In some embodiments, the additional optical fibers and the additional dummy fibers may naturally be positioned to rest in these gaps due to the force of gravity—thus, the positioning at operations 1302 and 1304 may serve as a form of passive alignment.

At operation 1306, additional optical fibers and any additional dummy fibers may be pressed into position using a fixture. At operation 1308, the additional optical fibers and the additional dummy fibers may be fixed in position. Fixation may occur in a variety of ways. For example, the additional optical fibers and the additional dummy fibers may be fixed by utilizing an adhesive or through laser welding. The fixture utilized at operation 1306 may continue to be used to press fibers into position while operation 1308 is executed, and the fixture is removed at operation 1310.

At operation 1312, a determination may be made as to whether additional layers of fibers shall be added. If the answer is yes, then the method 1300 may return to operation 1302, and the operations 1302-1310 may be performed iteratively until the desired number of layers have been added. Alternatively, if the answer is no at the determination of operation 1312, then the method 1300 may proceed to operation 1314.

At operation 1314, a cover may be added (although the cover may be optional in some embodiments). In some embodiments, the fixture utilized at operation 1306 may serve as a cover. Where this is the case, operation 1310 may not be performed and the fixture may be retained on the fiber array unit. Furthermore, the fixture may be fixed in position relative to the fiber array structure at operation 1308 where the fixture is utilized as a cover.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. A fiber array unit comprising:
a first set of optical fibers;
a first guide member and a second guide member; and
a fiber array structure having a surface, the surface defining a first groove and a second groove, the surface defining a first area between the first groove and the second groove,
wherein the first area is provided without any grooves,
wherein the first guide member is at least partially received in the first groove to assist in positioning the first guide member relative to the fiber array structure, wherein the second guide member is at least partially received in the second groove to assist in positioning the second guide member relative to the fiber array structure, and wherein each optical fiber of the first set of optical fibers is positioned between the first guide member and the second guide member, and
wherein the first guide member and the second guide member serve as sidewalls that assist in positioning and constrain the horizontal movement of the first set of optical fibers.

2. The fiber array unit of claim 1, further comprising:
a second set of optical fibers,
wherein the first set of optical fibers is positioned vertically between the first area and the second set of optical fibers, and wherein each optical fiber of the second set of optical fibers contacts another optical fiber of the first set of optical fibers.

3. The fiber array unit of claim 2, wherein an optical fiber of the second set of optical fibers is positioned such that it comes in contact with two optical fibers of the first set of optical fibers.

4. The fiber array unit of claim 3, wherein the first set of optical fibers and the second set of optical fibers are stacked in a staggered manner.

5. The fiber array unit of claim 1, wherein the first set of optical fibers is fixed to the first area.

6. The fiber array unit of claim 5, wherein the first set of optical fibers is fixed to the first area through laser welding or via adhesive.

7. The fiber array unit of claim 1, further comprising:
a first set of one or more dummy fibers; and
a second set of one or more dummy fibers,
wherein the first set of one or more dummy fibers and the second set of one or more dummy fibers contact the first area, wherein a first dummy fiber of the first set of one or more dummy fibers contacts the first guide member, wherein either the first dummy fiber or a second dummy fiber of the first set of one or more dummy fibers contacts a first optical fiber of the first set of optical fibers, wherein a first dummy fiber of the second set of one or more dummy fibers contacts the second guide member, wherein either the first dummy fiber or a second dummy fiber of the second set of one or more dummy fibers contacts a second optical fiber of the first set of optical fibers, wherein the first optical fiber of the first set of optical fibers is positioned at a first end of the first set of optical fibers, wherein the second optical fiber of the first set of optical fibers is positioned at a second end of the first set of optical fibers, and wherein the second end of the first set of optical fibers is opposite to the first end of the first set of optical fibers.

8. The fiber array unit of claim 1, wherein the first groove and the second groove are both V-grooves.

9. The fiber array unit of claim 1, wherein the first area defines a flat plane.

10. The fiber array unit of claim 1, wherein the first guide member and the second guide member are at least one of a guide pin, an optical fiber, or a dummy fiber.

11. The fiber array unit of claim 1, wherein the first guide member defines a first guide member cross-sectional area, wherein an optical fiber of the first set of optical fibers defines an optical fiber cross-sectional area, and wherein the first guide member cross-sectional area is greater than the optical fiber cross-sectional area.

12. The fiber array unit of claim 1, wherein the first set of optical fibers are positioned by application of force onto the first set of optical fibers via a first fixture.

13. The fiber array unit of claim 12, wherein the first fixture defines a first groove and a second groove, wherein the first groove is configured to at least partially receive the first guide member and the second groove is configured to at least partially receive the second guide member.

14. The fiber array unit of claim 13, wherein the first fixture defines a plurality of grooves positioned between the first groove and the second groove, and wherein each groove of the plurality of grooves is configured to at least partially receive an optical fiber of the first set of optical fibers.

15. The fiber array unit of claim 12, wherein the first fixture defines a plurality of grooves, and wherein each groove of the plurality of grooves is configured to at least partially receive an optical fiber of the first set of optical fibers.

16. The fiber array unit of claim 12, wherein the first fixture is removed after the first set of optical fibers is positioned.

17. The fiber array unit of claim 16, further comprising:
a second set of optical fibers,
wherein the first set of optical fibers is positioned vertically between the first area and the second set of optical fibers, wherein each optical fiber of the second set of optical fibers contacts the first set of optical fibers, and wherein the second set of optical fibers is positioned against the first set of optical fibers by application of force onto the second set of optical fibers via the first fixture.

18. The fiber array unit of claim 16, further comprising:
a second set of optical fibers,
wherein the first set of optical fibers is positioned vertically between the first area and the second set of optical fibers, wherein each optical fiber of the second set of optical fibers contacts the first set of optical fibers, and wherein the second set of optical fibers is positioned against the first set of optical fibers by application of force onto the second set of optical fibers via a second fixture.

19. The fiber array unit of claim 12, wherein the first fixture is fixed relative to the fiber array structure after the first set of optical fibers is positioned.

20. The fiber array unit of claim 1, wherein the first set of optical fibers, the first guide member, and the second guide member each possess a circular cross-section.
